(19) United States
(12) Patent Application Publication
(10) Pub. No.: US 2023/0113718 A1
(43) Pub. Date: Apr. 13, 2023

(54) SELF ORCHESTRATING NETWORK

(71) Applicant: View, Inc., Milpitas, CA (US)

(72) Inventors: Nitin KHANNA, Sunnyvale, CA (US); Darrel Q. PHAM, San Jose, CA (US); Daniel Dah TAI, San Jose, CA (US)

(21) Appl. No.: 17/906,052

(22) PCT Filed: Mar. 11, 2021
(86) PCT No.: PCT/US2021/021833

§ 371 Date: Sep. 9, 2022

Related U.S. Application Data
(63) Continuation-in-part of application No. 17/194,795, filed on Mar. 8, 2021.
Application No. 17/194,795 is a continuation of application No. PCT/US20/18677, filed on Feb. 18, 2020.
Application No. 17/194,795 is a continuation-in-part of application No. PCT/US21/17946, filed on Feb. 12, 2021.
Application No. PCT/US21/17946 is a continuation-in-part of application No. 16/447,169, filed on Jun. 20, 2019.
Application No. 16/447,169 is a continuation-in-part of application No. PCT/US19/30467, filed on May 2, 2019.
Application No. 17/194,795 is a continuation-in-part of application No. 17/083,128, filed on Oct. 28, 2020.
Application No. 17/083,128 is a continuation of application No. 16/664,089, filed on Oct. 25, 2019, now Pat. No. 11,294,254.
Application No. 16/664,089 is a continuation-in-part of application No. PCT/US2019/030467, filed on May 2, 2019.
Application No. 16/664,089 is a continuation-in-part of application No. PCT/US2018/029460, filed on Apr. 25, 2018.
Application No. 17/194,795 is a continuation-in-part of application No. 17/081,809, filed on Oct. 27, 2020, now Pat. No. 11,460,749.
Application No. 17/081,809 is a continuation of application No. 16/608,159, filed on Oct. 24, 2019, now Pat. No. 11,300,849.
(60) Provisional application No. 62/988,861, filed on Mar. 12, 2020.
(60) Provisional application No. 62/807,668, filed on Feb. 19, 2019.
(60) Provisional application No. 63/146,365, filed on Feb. 5, 2021.
(60) Provisional application No. 63/027,452, filed on May 20, 2020.
(60) Provisional application No. 62/978,755, filed on Feb. 19, 2020.
(60) Provisional application No. 62/977,001, filed on Feb. 14, 2020.
(60) Provisional application No. 62/988,861, filed on Mar. 12, 2020.
(60) Provisional application No. 62/688,957, filed on Jun. 22, 2018.
(60) Provisional application No. 62/858,100, filed on Jun. 6, 2019.
(60) Provisional application No. 62/803,324, filed on Feb. 8, 2019.
(60) Provisional application No. 62/768,775, filed on Nov. 16, 2018.
(60) Provisional application No. 62/666,033, filed on May 2, 2018.
(60) Provisional application No. 62/666,033, filed on May 2, 2018.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.
(60) Provisional application No. 62/607,618, filed on Dec. 19, 2017.
(60) Provisional application No. 62/523,606, filed on Jun. 22, 2017.
(60) Provisional application No. 62/507,704, filed on May 17, 2017.
(60) Provisional application No. 62/506,514, filed on May 15, 2017.
(60) Provisional application No. 62/490,457, filed on Apr. 26, 2017.

(51) Int. Cl. G02F 1/163; G05B 19/042; G06F 3/044; G05B 15/02; G02F 1/15; B32B 17/10; E06B 9/24; G02F 1/155; G06F 3/041; H02J 50/80; H02J 50/20; G09F 19/22; G06F 3/14; G09G 3/38

(52) U.S. Cl. CPC G02F 1/163; G05B 19/0426; G06F 3/044; G05B 15/02; H01L 27/3234; G02F 1/15; B32B 17/10513; E06B 9/24; G02F 1/155; G06F 3/0412; H01L 51/52; H02J 50/80; H02J 50/20; G05B 19/042; G09F 19/227; G06F 3/1446; G09G 3/38; H04K 3/45

(57) ABSTRACT

Disclosed herein are various clusters. A cluster comprises processing nodes that have supervisory roles and subordinate roles. A node in the cluster can have a supervisory or a subordinate role. The cluster can self-orchestrate its roles. The roles of the nodes can be assigned and/or reassigned (e.g., autonomously and/or automatically) by the cluster. Such system may achieve automatic commissioning of the cluster(s), e.g., in a facility.

### RELATED APPLICATIONS

This application claims priority from U.S. Provisional Patent Application Ser. No. 62/988,861, filed Mar. 12, 2020, titled, “SELF ORCHESTRATING NETWORK,” which is incorporated by reference herein in its entirety. This application is also continuation in part of U.S. patent application Ser. No. 17/194,795 filed Mar. 8, 2021 titled “REMOTE MANAGEMENT OF A FACILITY,” that is a national entry of International Patent Application Serial No. PCT/US20/18677, filed Feb. 18, 2020, titled “REMOTE MANAGEMENT OF A FACILITY,” which claims priority to U.S. Provisional Patent Application Ser. No. 62/807,668, filed Feb. 19, 2019, titled “CLOUD-BASED TECHNIQUES FOR MANAGING SITES HAVING SWITCHABLE OPTICAL DEVICES,” each of which is incorporated by reference herein in its entirety.

### BACKGROUND

A processing system may have a plurality of nodes that may be linked together within a network. The processing system can be a control system wherein some nodes may include software and/or hardware that may be configured to operate various systems in one or more facilities (i.e., enclosures). Facilities can include at least one building or any portion(s) of the building. The operating systems to be controlled can include smart windows (e.g., having insulated glass units such as electrochromic devices), building management systems, environmental sensors, and/or actuators (e.g., HVAC systems). When deploying processing hardware (e.g., and software) system including multiple processing nodes in order to create and maintain an on-premises, hierarchical controller network; it is at times commissioned by labor intensive and lengthy assignment of the nodes (e.g., control nodes among many control and functional elements) that is entirely, or at least partially, manual. When new nodes are added to a preformed system, these newly added nodes typically also require manual, or at least partially manual, assignment to the system; oftentimes including reprogramming the existing system to accommodate the new node(s). Such manual installation methodology can result in substantial costs and/or can be prone to human error. The human errors can lead to detrimental malfunction of such a complex system and/or compromise of data security.

### SUMMARY

Various aspects disclosed herein alleviate as least part of the shortcomings related to commissioning multiple processing nodes in an on-premises network.

In an aspect, software setup and installation (i.e., commissioning) of the nodes can occur automatically, e.g., by pre-installing a self-orchestrating control scheme in each of the nodes (e.g., processors). The cost, labor, maintenance, and/or support associated with deployment of a processing system can be reduced while avoiding many potential sources of human error. A self-orchestrating system can provide increased robustness by avoiding a single point of failure (e.g., due to a malfunction of a single node).

In another aspect, a method for deployment of at least one work order, the method comprises: (a) activating a plurality of nodes as observer agents, which plurality of nodes forms a cluster; (b) using an observer agent of the observer agents to broadcast a query to the cluster and wait for a response, which query inquires whether any of the plurality of nodes is assigned a role of a Master Node; (c) if the observer agent does not receive a positive response to the query, assigning (i) the role of the Master Node to the observer agent and (ii) a role of a Worker Node to any node of the plurality of nodes different from the Master Node to form at least one Worker Node; and (d) using the Master Node to (I) retrieve at least one work order and (II) orchestrate the at least one work order among any of the at least one Worker Node.

In some embodiments, the deployment of at least one work order is deployment of at least one work order in a local network of a facility (e.g., the first network implemented in the facility upon its construction, and/or a network disposed at least in part in an external envelope of the facility). In some embodiments, the plurality of nodes is disposed in a facility and is operatively couped to the local network of the facility. In some embodiments, the Master Node deploys the at least one work order to the at least one Worker Node. In some embodiments, the at least one Worker Node is communicatively coupled to at least one device disposed in the facility (e.g., in an enclosure of the facility). In some embodiments, the at least one device is included in a device ensemble comprising sensors or a sensor and an emitter. In some embodiments, the network is configured to transmit communication and power on one cable (e.g., a coaxial cable). In some embodiments, the communication comprises cellular communication conforming to at least a third generation (3G), fourth generation (4G), or fifth generation (5G) cellular communication protocol. In some embodiments, the communication comprises media or control communication. In some embodiments, the network is operatively coupled to a control system configured to control an environment, or a messaging system (e.g., an alarm system, a safety system, a health system, an entertainment system, or an educational system) of the facility. In some embodiments, the at least one work orders include one or more commands for operating the device. In some embodiments, a plurality of observer agents assigns the role of Master Node to more than one node of the plurality of nodes to form a plurality of Master Nodes, and wherein the plurality of Master Nodes handles deployment of work orders. In some embodiments, the plurality of Master Nodes handles deployment of work orders communally. In some embodiments, the plurality of Master Nodes handles deployment of work orders hierarchically. In some embodiments, a first Master node of the plurality of Master Nodes handles deployment of a first group of work orders, and a second Master node of the plurality of Master Nodes handles deployment of a second group of work orders. In some embodiments, the first group of work orders and the second group of work orders differ in their order timing, deployment timing, device type they target, and/or device location they target. In some embodiments, the assignment of the Master Node is at least in part according to (A) one or more assertions made by the Master Node and (B) a time order in which the one or more assertions occur. In some embodiments, the Master Node is a first Master Node, and wherein the observer agent is a first observer agent, wherein the query is a first query, and wherein the method further comprises using a second observer agent of the observer agents to broadcast a second query to the cluster that at least partially overlaps in time broadcasting of the first query, which second query inquires whether any of the plurality of nodes is assigned a role of a Master Node. In some embodiments, the method further comprises: (A) determining a number of nodes that comprises the cluster; and (B) if the number exceeds a threshold then promoting a role of at least one Worker Node to the role of Master Node. In some embodiments, a total number of Master Nodes after promoting the Worker Nodes is an odd number. In some embodiments, the Worker Node promoted is selected randomly. In some embodiments, a plurality of Worker Nodes is promoted to the role of Master Node, and wherein the promoted Worker Nodes are selected according to a time sequence. In some embodiments, the time sequence is comprised of a sequential list comprising an order in which Worker Nodes joined the cluster. In some embodiments, a plurality of Worker Nodes is promoted to the role of Master Node, and wherein the promoted Worker Nodes are selected from Worker Nodes that respond to a broadcast message sent by an observer agent. In some embodiments, the method further comprises the Master Node initializing the cluster. In some embodiments, initializing the cluster includes electronically retrieving a service deployment document via a remote transfer from a predetermined location outside the cluster. In some embodiments, initializing the cluster includes configuring a respective orchestrator in the Worker Node according to the service deployment document.

In another aspect, an apparatus for deployment of at least one work order, comprises a plurality of nodes that form a cluster, the plurality of nodes comprising circuitry configured to: (a) activate a plurality of nodes as observer agents; (b) use an observer agent of the observer agents to broadcast a query to the cluster and wait for a response, which query inquires whether any of the plurality of nodes is assigned a role of a Master Node; (c) if the observer agent does not receive a positive response to the query, assign (i) the role of the Master Node to the observer agent and (ii) a role of Worker Node to any node of the plurality of nodes different from the Master Node to form at least one Worker Node; and (d) use the Master Node to (I) retrieve at least one work order and (II) orchestrate the at least one work order among any of the at least one Worker Node.

In some embodiments, the Apparatus is for deployment of at least one work order in a local network of a facility, comprising a plurality of nodes (i) that is disposed in a facility, and/or (iii) that is operatively couped to a local network of the facility (e.g., the first network implemented in the facility upon its construction, and/or a network disposed at least in part in an external envelope of the facility). In some embodiments, the apparatus is configured so that the Master Node deploys the at least one work order to the at least one Worker Node. In some embodiments, the apparatus is configured so that the at least one Worker Node is communicatively coupled to at least one device disposed in the facility (e.g., in an enclosure of the facility). In some embodiments, the at least one work orders includes one or more commands for operating the at least one device. In some embodiments, the at least one device is included in a device ensemble comprising sensors or a sensor and an emitter. In some embodiments, the network is configured to transmit communication and power on one cable (e.g., a coaxial cable). In some embodiments, the communication comprises cellular communication conforming to at least a third generation (3G), fourth generation (4G), or fifth generation (5G) cellular communication protocol. In some embodiments, the communication comprises media or control communication. In some embodiments, the network is operatively coupled to a control system configured to control an environment, or a messaging system (e.g., an alarm system, a safety system, a health system, an entertainment system, or an educational system) of the facility. In some embodiments, the apparatus is configured so that a plurality of observer agents assigns the role of Master Node to more than one node of the plurality of nodes to form a plurality of Master Nodes, and wherein the plurality of Master Nodes handles deployment of work orders. In some embodiments, the plurality of Master Nodes handles deployment of work orders communally. In some embodiments, the plurality of Master Nodes handles deployment of work orders hierarchically. In some embodiments, a first Master node of the plurality of Master Nodes handles deployment of a first group of work orders, and a second Master node of the plurality of Master Nodes handles deployment of a second group of work orders. In some embodiments, the first group of work orders and the second group of work orders differ in their order timing, deployment timing, device type they target, and/or device location they target. In some embodiments, the apparatus is configured so that the assignment of the Master Node is at least in part according to (A) one or more assertions made by the Master Node and (B) a time order in which the one or more assertions occur. In some embodiments, the apparatus is configured so that the Master Node is a first Master Node, and wherein the observer agent is a first observer agent, wherein the query is a first query, and wherein a second observer agent of the observer agents broadcasts a second query to the cluster that overlaps in time broadcasting of the first query, which second query inquires whether any of the plurality of nodes is assigned a role of a Master Node. In some embodiments, the apparatus is configured to: (A) determine a number of nodes that comprises the cluster; and (B) if the number exceeds a threshold then promote a role of at least one Worker Node to the role of Master Node. In some embodiments, the apparatus is configured such that a total number of Master Nodes after promoting the Worker Nodes is an odd number. In some embodiments, the apparatus is configured such that the Worker Node promoted is selected randomly. In some embodiments, the apparatus is configured such that a plurality of Worker Nodes is promoted to the role of Master Node, and wherein the promoted Worker Nodes are selected according to a time sequence. In some embodiments, the apparatus is configured such that the time sequence is comprised of a sequential list comprising an order in which Worker Nodes joined the cluster. In some embodiments, the apparatus is configured such that a plurality of Worker Nodes is promoted to the role of Master Node, and wherein the Worker Nodes promoted are selected from Worker Nodes that respond to a broadcast message sent by an observer agent. In some embodiments, the apparatus is further configured such that the Master Node initializes the cluster. In some embodiments, the apparatus is configured such that initializing the cluster includes electronically retrieving a service deployment document via a remote transfer from a predetermined location outside the cluster. In some embodiments, the apparatus is configured such that initializing the cluster includes configuring a respective orchestrator in the Worker Node according to the service deployment document.

In another aspect, a non-transitory computer program product for deployment of at least one work order, which non-transitory computer program product contains instructions inscribed thereon which, when executed by one or more processors, cause the one or more processors to execute operations, comprises: (a) activating a plurality of nodes as observer agents, which plurality of nodes forms a cluster; (b) using an observer agent of the observer agents to broadcast a query to the cluster and wait for a response, which query inquires whether any of the plurality of nodes is assigned a role of a Master Node; (c) if the observer agent does not receive a positive response to the query, assigning (i) the role of the Master Node to the observer agent and (ii) a role of Worker Node to any node of the plurality of nodes different from the Master Node to form at least one Worker Node; and (d) using the Master Node to (I) retrieve at least one work order and (II) orchestrate the at least one work order among any of the at least one Worker Node.

In some embodiments, deployment of at least one work order is in a local network of a facility (e.g., the first network implemented in the facility upon its construction, and/or a network disposed at least in part in an external envelope of the facility). In some embodiments, the plurality of nodes is disposed in a facility and is operatively couped to the local network of the facility. In some embodiments, the plurality of nodes includes the one or more processors. In some embodiments, the one or more processors include the plurality of nodes. In some embodiments, the Master Node deploys the at least one work order to the at least one Worker Node. In some embodiments, the at least one Worker Node is communicatively coupled to at least one device disposed in the facility (e.g., in an enclosure of the facility). In some embodiments, the at least one work order includes one or more commands for operating the at least one device. In some embodiments, the at least one device is included in a device ensemble comprising sensors or a sensor and an emitter. In some embodiments, the network is configured to transmit communication and power on one cable (e.g., a coaxial cable). In some embodiments, the communication comprises cellular communication conforming to at least a third generation (3G), fourth generation (4G), or fifth generation (5G) cellular communication protocol. In some embodiments, the communication comprises media or control communication. In some embodiments, the network is operatively coupled to a control system configured to control an environment, or a messaging system (e.g., an alarm system, a safety system, a health system, an entertainment system, or an educational system) of the facility. In some embodiments, a plurality of observer agents assigns the role of Master Node to more than one node of the plurality of nodes to forms a plurality of Master Nodes, and wherein the plurality of Master Nodes handles deployment of work orders. In some embodiments, the plurality of Master Nodes handles deployment of work orders communally. In some embodiments, the plurality of Master Nodes handles deployment of work orders hierarchically. In some embodiments, a first Master node of the plurality of Master Nodes handles deployment of a first group of work orders, and a second Master node of the plurality of Master Nodes handles deployment of a second group of work orders. In some embodiments, the first group of work orders and the second group of work orders differ in their order timing, deployment timing, device type they target, and/or device location they target. In some embodiments, the assignment of the Master Node is at least in part according to (A) one or more assertions made by the Master Node and/or (B) a time order in which the one or more assertions occur. In some embodiments, Master Node is a first Master Node, and wherein the observer agent is a first observer agent, wherein the query is a first query, and wherein the operations further comprise using a second observer agent of the observer agents to broadcast a second query to the cluster that overlaps in time broadcasting of the first query, which second query inquires whether any of the plurality of nodes is assigned a role of a Master Node. In some embodiments, the operations further comprise: (A) determining a number of nodes that comprises the cluster; and (B) if the number exceeds a threshold then promoting a role of at least one Worker Node to the role of Master Node. In some embodiments, a total number of Master Nodes after promoting the Worker Nodes is an odd number. In some embodiments, the Worker Node promoted is selected randomly. In some embodiments, a plurality of Worker Nodes is promoted to the role of Master Node, and wherein the promoted Worker Nodes are selected according to a time sequence. In some embodiments, the time sequence is comprised of a sequential list comprising an order in which Worker Nodes joined the cluster. In some embodiments, a plurality of Worker Nodes is promoted to the role of Master Node, and wherein the promoted Worker Nodes are selected from Worker Nodes which respond to a broadcast message sent by an observer agent. In some embodiments, the non-transitory computer program product, further comprises the Master Node initializing the cluster. In some embodiments, initializing the cluster includes electronically retrieving a service deployment document via a remote transfer from a predetermined location outside the cluster. In some embodiments, initializing the cluster includes configuring a respective orchestrator in the Worker Node according to the service deployment document.

In another aspect, the present disclosure provides systems, apparatuses (e.g., controllers), and/or non-transitory computer-readable medium (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product, comprising a non-transitory computer-readable medium in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable medium comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium coupled thereto. The non-transitory computer-readable medium comprises machine-executable code that, upon execution by the one or more processors, implements any of the methods disclosed herein and/or effectuates directions of the controller(s) disclosed herein.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 shows a perspective view of an enclosure (e.g., a building) having an associated processing/control system;

FIG. 2 shows an example of a control system architecture;

FIG. 3 shows a block diagram of example modules of a network or local controller;

FIG. 4 schematically depicts network nodes disposed in various enclosures, such as floors of a building;

FIG. 5 schematically shows a plurality of nodes within a cluster;

FIG. 6 shows a block diagram with example functions associated with an orchestrator component of a Master node;

FIG. 7 shows a schematic diagram of a controller;

FIG. 8 shows a block diagram of a network architecture;

FIG. 9 shows a flowchart of a boot operations for a node;

FIG. 10 shows a flowchart for assigning a Master node role;

FIG. 11 shows a flowchart for a Master node;

FIG. 12 shows a flowchart for a response of a Master node to a request;

FIG. 13 shows a flowchart for assigning a plurality of Master nodes;

FIG. 14 shows a flowchart for assigning a plurality of Master nodes;

FIG. 15 shows a flowchart for assigning a plurality of Master nodes;

FIGS. 16A, 16B, and 16C schematically show block diagrams of various examples of clusters;

FIG. 17 schematically depicts a processing system;

FIG. 18 schematically shows a cross section of an Integrated Glass Unit (IGU); and

FIG. 19 shows a flowchart of various phases of operation.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs.

The term “operatively coupled” or “operatively connected” refers to a first element (e.g., mechanism) that is coupled (e.g., connected) to a second element, to allow the intended operation of the second and/or first element. The coupling may comprise physical or non-physical coupling. The non-physical coupling may comprise signal-induced coupling (e.g., wireless coupling). Coupled can include physical coupling (e.g., physically connected), or non-physical coupling (e.g., via wireless communication).

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling or a side wall. The closable opening may be closed by at least one window or door. The enclosure may be at least a portion of a facility. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, a plane, a ship, a vehicle, or a rocket).

In some embodiments, the enclosure encloses an atmosphere. The atmosphere may comprise one or more gases. The gases may include inert gases (e.g., argon or nitrogen) and/or non-inert gases (e.g., oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, emitter, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network.

In some embodiments, a building management system (BMS) is a computer-based control system installed in a building that monitors and otherwise controls (e.g., regulates, manipulates, restricts, directs, monitors, adjusts, modulates, varies, alters, restrains, checks, guides, and/or manages) the building. For example, the BMS may control the mechanical and/or electrical equipment such as ventilation, lighting, power systems, elevators, fire systems, and/or security systems. Controllers (e.g., nodes and/or processors), e.g., as described herein, may be suited for integration with a BMS. A BMS may consist of hardware, including interconnections by communication channels to one or more computers (e.g., and associated software) for maintaining one or more conditions in the building. The one or more conditions in the building may be according to preference(s) set by a user (e.g., an occupant and/or a building manager). For example, a BMS may be implemented using a local area network, such as Ethernet. The software can be based on, e.g., internet protocols and/or open standards. One example is software from Tridium, Inc. (of Richmond, Va.). One communication protocol that can be used with a BMS is BACnet (building automation and control networks). A node can be any addressable circuitry. For example, a node can be a circuitry that has an Internet Protocol (IP) address.

In some embodiments, a BMS may be implemented in a building, e.g., a multi-story building. The BMS may function (also) to control one or more characteristics of an environment in the building. The one or more characteristics may comprise: temperature, carbon dioxide levels, gas flow, and/or humidity in a building. There may be many mechanical devices that are controlled by a BMS such as heaters, air conditioners, blowers, and/or vents. To control the building environment, a BMS may turn on and off these various devices under defined conditions. A core function of a BMS may be to maintain a comfortable environment for occupants of the environment, e.g., while minimizing heating and cooling costs/demand. A BMS can be used to control the various systems. A BMS may be used to optimize the synergy between various systems. For example, the BMS may be used to conserve energy and lower building operation costs. The multi-story building may have at least 2, 8, 10, 25, 50, 80, 100, 120, 140, or 160 floors that are controlled by the control system. The number of controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m²to about 2000 m², from about 150 m²to about 500 m², from about 250 m² to about 1000 m², or from about 1000 m² to about 2000 m²).

In some embodiments, a window controller can be integrated with a BMS. For example, the window controller can be configured to control one or more tintable windows (e.g., electrochromic windows). In one embodiment, the one or more electrochromic windows include at least one all solid state and inorganic electrochromic device, but may include more than one electrochromic device, e.g. where each lite or pane of an IGU is tintable. In one embodiment, the one or more electrochromic windows include only all solid state and inorganic electrochromic devices. In one embodiment, the electrochromic windows are multistate electrochromic windows. Examples of tintable windows can be found in, in U.S. patent application Ser. No. 12/851,514, filed on Aug. 5, 2010, and titled “Multipane Electrochromic Windows,” which is incorporated herein by reference in its entirety.

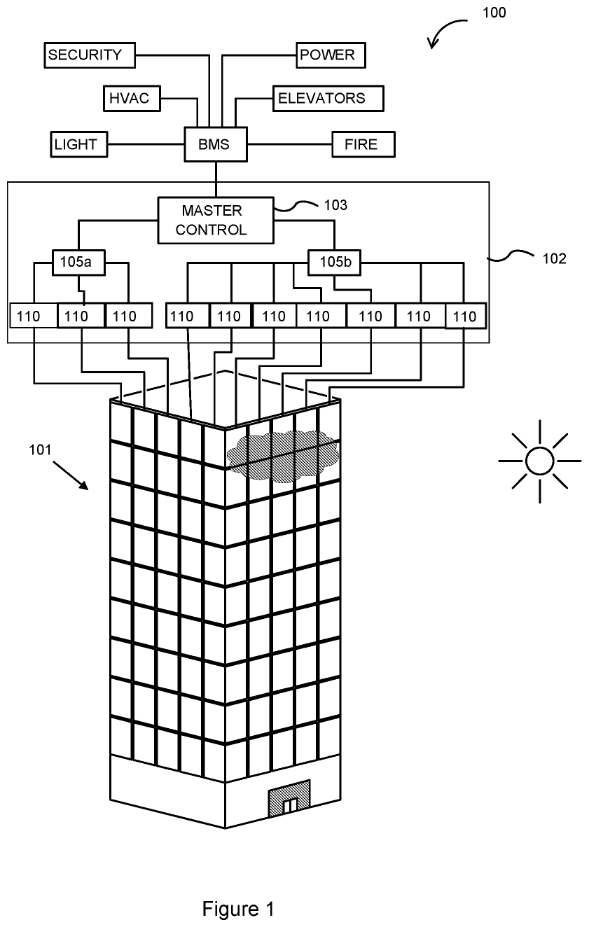

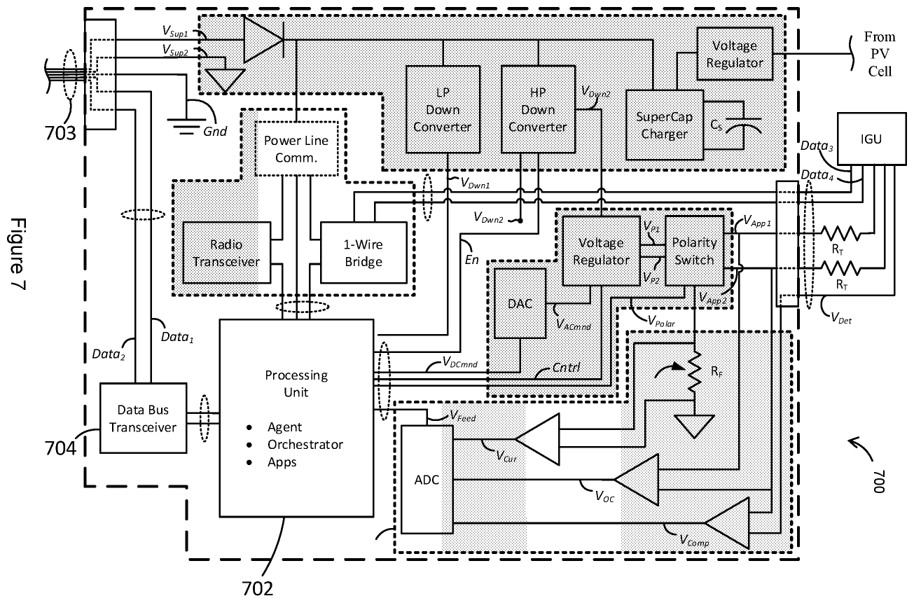

FIG. 1 shows an example of a schematic diagram of an embodiment of a BMS 100, that manages a number of systems of a building 101. The systems in the building can include including security systems, heating/ventilation/air conditioning (HVAC), lighting of the building, power systems, elevators, and/or fire systems. Security systems may include magnetic card access, turnstiles, solenoid driven door locks, surveillance cameras, burglar alarms, and/or metal detectors. Fire systems may include fire alarms and/or fire suppression systems (e.g., including a water plumbing control). Lighting systems may include interior lighting, exterior lighting, emergency warning lights, emergency exit signs, and/or emergency floor egress lighting. Power systems may include the main power, backup power generators, and/or uninterrupted power source (UPS) grids. BMS 100 can manage a master controller 103 that is a master window controller. Master controller 103 is depicted in the example shown in FIG. 1, as a distributed network of window controllers including a master controller 103, intermediate controllers 105a and 105b , and end controllers (or leaf controllers) 110. The end (or leaf) controllers can be referred to herein as “local controllers.” End (or leaf) controllers 110 may be similar to controller 700 described with respect to FIG. 7. For example, master controller 103 may be in proximity to the BMS 100, and at least one floor of building 101 may have one or more intermediate controllers 105a and 105b, while at least one device (e.g., window) of the building has its own local (e.g., end) controller 110. At least one of controllers 110 can control a specific electrochromic window of building 101. A local controller (e.g., a window controller) can control at most 1, 2, 3, 4, 5, 6, 7, 8, 9, or 10 devices. A local controller can control a number of devices between the aforementioned number of devices (e.g., from 1 to 10, from 1 to 8, or from 5 to 10 devices). A master controller can control at most 1, 2, 3, 4, 5, or 6 intermediate controllers residing in one floor of a building. A master controller can control a number of intermediate controllers between the aforementioned number of intermediate controllers residing in a single floor (e.g., from 1 to 6, from 1 to 4, or from 3 to 6 intermediate controllers).

In some embodiments, a local controller is communicatively coupled to at least one device. A local controller can be disposed in a separate location from the device (e.g., electrochromic window, a sensor, or an emitter) that it controls or be integrated into that device. For simplicity, in the example shown in FIG. 1, ten local controllers 110 of building 101 are depicted as controlled by master window controller 103, however, a greater or smaller number of local controllers can be controlled directly or indirectly by the master controller. In the example shown in FIG. 1, three local controllers 110 are controlled by intermediate controller 105a that is controlled by the master controller 103; and seven local controllers 110 are controlled by intermediate controller 105b that is controlled by the master controller 103. One or more devices (e.g., tintable windows, sensors, or emitters) can be controlled by a local controller. In a typical setting there may be a large number of electrochromic windows in a building controlled by master controller. Master window controller need not be a distributed network of window controllers. For example, a single end controller that controls the functions of a single tintable window may also fall within the scope of the embodiments disclosed herein.

In some embodiments, a BMS includes a multipurpose controller, e.g., as described herein. By incorporating feedback (e.g., of the controller), a BMS can provide, for example, enhanced: 1) environmental control, 2) energy savings, 3) security, 4) flexibility in control options, 5) improved reliability and usable life of other systems (e.g., due to decreased reliance thereon and/or reduced maintenance thereof), 6) information availability and/or diagnostics, 7) higher productivity from personnel in the building (e.g., staff), and various combinations thereof. These enhancements may derive automatically controlling any of the devices. In some embodiments, a BMS may not be present. In some embodiments, a BMS may be present and may not communicate with a master network controller. In some embodiments, a BMS may communicate with a portion of the levels in the hierarchy of controllers. For example, the BMS may communicate (e.g., at a high level) with a master network controller. In some embodiments, a BMS may not communicate with a portion of the levels in the hierarchy of controllers of the control system. For example, the BMS may not communicate with the local controller and/or intermediate controller. In certain embodiments, maintenance on the BMS would not interrupt control of the devices communicatively coupled to the control system.

In some embodiments, a processing system may maintain a hierarchical control structure. The processing system (e.g., programmable processor-based networks and/or controller networks) may coordinate operation of electronic components (e.g., electronic devices and/or systems) installed at an enclosure. The enclosure may be a facility of an entity/enterprise such as a building. However, the physical processing devices or units (e.g., nodes) materializing these hierarchical roles may have a layout or interconnection that varies from (e.g., may not reflect) the layers shown. The nodes can be adapted to operate in a labile fashion. The labile fashion may enable the nodes to emulate changeable hierarchical control structures.

In some embodiments, the processing nodes are organized into a hierarchical structure. Although the processing system may implement the hierarchical control scheme, the structure of individual processors and/or nodes and their interconnections giving rise to the hierarchical scheme, may be organized in a manner that does not have to physically conform to such a hierarchy (and which may change dynamically during operation). A hierarchical control scheme can have levels and/or organization of functions. For example, a hierarchy can comprise two, three, four, or five levels.

In some embodiments, the control system has a hierarchal structure. A hierarchical structure (control scheme and/or hardware organization) may be useful for larger systems wherein (I) higher-level node(s) perform higher level functions (e.g., computations, command generation, data collection, data distribution, data communication, and/or data authentication) and (II) lower-level nodes perform lower-level functions (e.g., direct control of operational devices such as IGU, by using sensor measurements and/or Al). The functions of the lower level nodes may be performed according to programming and/or in response to commands via higher level and/or user input. Higher level input may refer to input from higher level in the hierarchy of controllers. Some examples of hierarchical systems include (a) a smart building (e.g., with interacting systems), (b) insulated glass units or IGUs (including electrochromic devices), (c) a BMS, (d) a network of sensors, (e) a collection of control devices (e.g., HVAC components), (f) data centers (either local or distributed), (g) server farms, (h) data storage facilities, (i) data security services, (j) cellular service provider facilities such as a cellular base station (e.g., for handset tracking and call provisioning). The smart building can be a facility. The facility may comprise a room, a building, several buildings, or a collection of portions from one or more buildings.

In some embodiments, deployment of the hierarchy of controllers in the facility may be elaborate. The control systems may provide advantages in scaling and reliability of installations. Some known hierarchical systems have required extensive manual layout, selection, and/or configuration of nodes, e.g., according to the intended construction and/or capabilities of the individual installations. As the number of nodes and/or functionalities increase, the set-up and modification to a network can become increasingly complex and labor intensive. Such manual installation methodology can result in substantial costs and/or can be prone to human error. The human errors can lead to (e.g., detrimental) malfunction of such a complex system and/or compromise of data security.

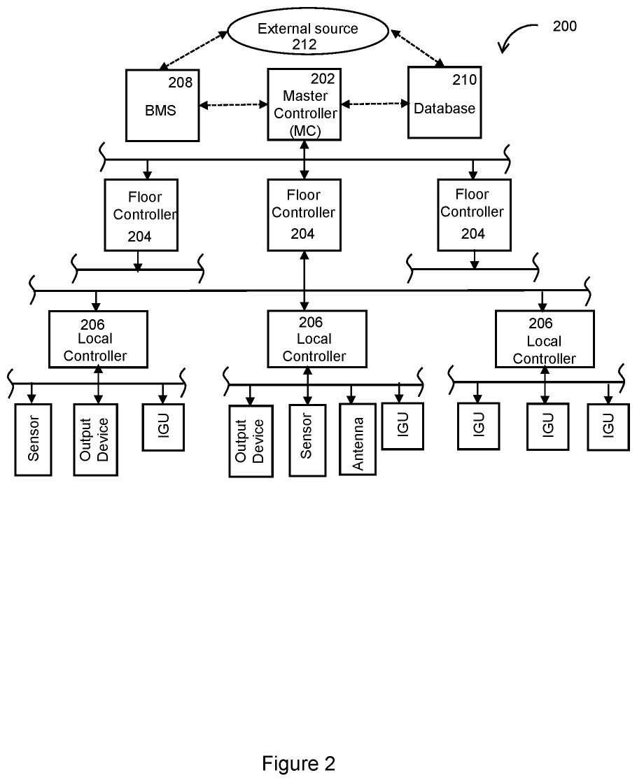

In some embodiments, a processing system has a hierarchical structure including a master controller at a highest level, floor controllers (e.g., that may comprise network controllers) at an intermediate level, and local controllers (e.g., window controllers) at a lowest level. FIG. 2 shows an example of a control system architecture 200 comprising a master controller 202 that controls floor controllers 204, that in turn control local controllers 206. In some embodiments, a local controller controls one or more IGUs, one or more sensors, one or more output devices (e.g., one or more emitters), or any combination thereof. FIG. 2 shows an example of a configuration in which the master controller is operatively coupled (e.g., wirelessly and/or wired) to a building management system (BMS) 208 and to a database 210. Arrows in FIG. 2 represent communication pathways. A controller may be operatively coupled (e.g., directly/indirectly and/or wired and wirelessly) to an external source 212. The external source may comprise a network. The external source may comprise one or more sensor or output devices. The external source may comprise a cloud-based application and/or database. One or more higher hierarchy levels may be disposed out of the facility (e.g., at a different location or in the cloud). The communication may be wired and/or wireless. The external source may be disposed external to the facility. For example, the external source may comprise one or more sensors and/or antennas disposed, e.g., on a wall or on a ceiling of the facility. The communication may be mono-directional or bidirectional. In the example shown in FIG. 2, all communication arrows are meant to be bidirectional.

In some embodiments, the sensor(s) are operatively (e.g., communicatively) coupled to at least one controller and/or processor. Sensor readings may be obtained by one or more processors and/or controllers. A controller may comprise a processing unit (e.g., CPU or GPU). A controller may receive an input (e.g., from at least one sensor). The controller may comprise circuitry, electrical wiring, optical wiring, socket, and/or outlet. A controller may deliver an output. A controller may comprise multiple (e.g., sub-) controllers. The controller may be a part of a control system. A control system may comprise a master controller, a floor (e.g., comprising network controller) controller, or a local controller. The local controller may be a window controller (e.g., controlling an optically switchable window), enclosure controller, or component controller. For example, a controller may be a part of a hierarchal control system (e.g., comprising a main controller that directs one or more controllers, e.g., floor controllers, local controllers (e.g., window controllers), enclosure controllers, and/or component controllers). A physical location of the controller type in the hierarchal control system may be changing. For example: (I) at a first time: a first processor may assume a role of a main controller, a second processor may assume a role of a floor controller, and a third processor may assume the role of a local controller; (II) at a second time: the second processor may assume a role of a main controller, the first processor may assume a role of a floor controller, and the third processor may remain with the role of a local controller; and (III) at a third time: the third processor may assume a role of a main controller, the second processor may assume a role of a floor controller, and the first processor may assume the role of a local controller. A controller may control one or more devices (e.g., be directly coupled to the devices). Direct coupling between a first controller and a first device may refer to an absence of any other (second) controller or (second) device between the first controller and the first device. The coupling may facilitate direct communication. The coupling may be wireless and/or wired. A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). The output device may be referred to herein as an “emitter.”

In one embodiment, a floor controller directs at least one local controller. A floor controller may direct one or more window controllers, one or more enclosure controllers, one or more component controllers, or any combination thereof. The floor controller may comprise a network controller. The floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. There may be one or more floor controllers in a floor of a facility (e.g., depending on the floor size and/or number of devices in the floor that are coupled to the control system). For example, a floor controller may be assigned to a portion of the local controllers disposed in the facility. For example, a floor controller may be assigned to a portion of the floors of a facility. A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system.

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m²to about 2000 m², from about 150 m²to about 500 m², from about 250 m² to about 1000 m², or from about 1000 m² to about 2000 m²). The facility may comprise a commercial or a residential building. The residential facility may comprise a multi or a single family building. The one or more devices may comprise a sensor. The sensor may be configured (e.g., designed) to measure one or more environmental characteristics, for example, temperature, humidity, ambient noise, carbon dioxide, VOC, particulate matter, oxygen, and/or any other aspects of an environment (e.g., atmosphere thereof). The control system may be configured to control at least one environmental characteristic of the facility (including an enclosure of the facility) The at least one environmental characteristic may comprise temperature, humidity, fine spray (e.g., aerosol), sound, electromagnetic waves (e.g., light glare, and/or color), gas makeup, gas concentration, gas speed, vibration, volatile compounds (VOCs), debris (e.g., dust), or biological matter (e.g., gas borne bacteria and/or virus). The gas(es) may comprise oxygen, nitrogen, carbon dioxide, carbon monoxide, hydrogen sulfide, Nitric oxide (NO) and nitrogen dioxide (NO₂), inert gas, Nobel gas (e.g., radon), chlorophore, ozone, formaldehyde, methane, or ethane. For example, the control system may control temperature, carbon dioxide levels, and/or humidity in an enclosure. The control system may utilize a building management system (BMS), e.g., for the environmental control. The one or more devices may comprise a sounds system, lighting, ventilation system, heating system, cooling system, heating ventilation and air conditioning system (HVAC), control entry system (e.g., electrical doors), windows (e.g., tintable windows such as electrochromic windows), dispensers, third party service devices (e.g., vending machine), machinery (e.g., factory machinery such as heavy machinery), media display (e.g., digital data screen such as television screens), communication hubs, antenna, air circulation system air sanitation systems, other sanitation systems, safety (e.g., alarm) systems, messaging systems, servers (e.g., data servers), sensing system, emission systems (e.g., light, gas, and/or volatile compounds such as smell conditioners), or any combination thereof. The dispensers may dispense liquid, foam, gel, or gas. The dispensers may dispense one or more products (e.g., syringe, medication, goggle, and/or mask). The dispensers may dispense safety, health, and/or identification products (e.g., ID cards). The dispensers may be dispense entertainment, and/or manufacturing related products (e.g., nuts, bolts, screws, or screw drivers). The dispensers may dispense work tools. The control may rely on sensor data (e.g., using feedback and/or closed loop control schemes).

In some embodiments, the control system includes at least one controller. The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g. temperature, power, voltage, and/or profile). The control can comprise real time or off-line control. A calculation utilized by the controller can be done in real time, and/or off-line. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer.

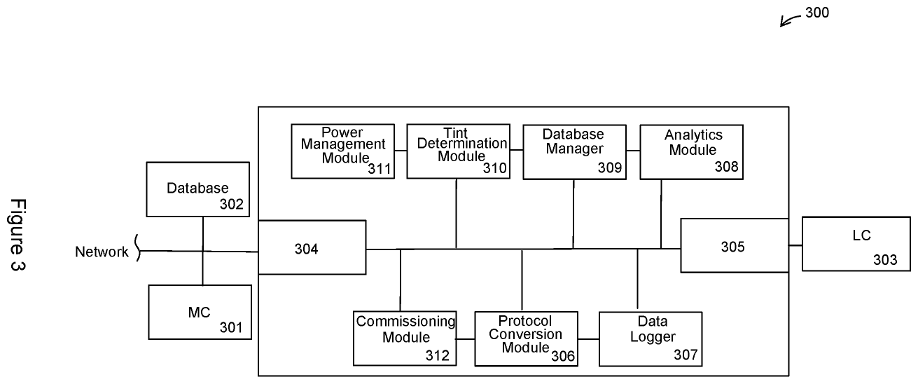

In some embodiments, a floor controller (e.g., a network controller) comprises circuitry. Examples of controllers (e.g., and circuitry thereof) are described in U.S. Pat. No. 10,495,939, issued Dec. 3, 2019, titled “CONTROLLERS FOR OPTICALLY-SWITCHABLE DEVICES,” which is incorporated herein by reference in its entirety. In some embodiments, a floor controller can take over some of the functions, processes and/or operations of a master controller. The floor controller can include additional functionalities and/or capabilities not described with reference to the master controller. FIG. 3 shows an example of a block diagram of modules of a network controller. The modules of FIG. 3 can be implemented in the floor controller in any suitable combination of hardware, firmware and software. In some embodiments in which the floor controller is implemented as a network controller application executing in a computer, each of the modules of FIG. 3 can be implemented as an application and/or task (or subtask) executing within the network controller application. The floor controller can perform as a master controller (e.g., when their roles exchange). In some embodiments, functions performed by the floor controller can include protocol conversion, data logging, analytics, database management, tint determination, power management, and/or commissioning. The floor controller may be communicatively coupled by a downstream network interface to one or more local controllers (e.g., window controllers). The floor controller may be communicatively coupled by an upstream network interface to a master controller (e.g., when the floor controller is not functioning as the master controller) and a database. As compared to the local controller(s), the floor controller and or the master controller comprise a Higher Hierarchy Controller (abbreviated herein as “HHC”). Communicative coupling may comprise wired and/or wireless communication.

In some embodiments, a higher hierarchy controller (HHC) includes one or more modules (e.g., functionalities). For example, the HCC can have one or more modules including protocol conversion module, a data logger, an analytics module, a database manager, a tint determination module, a power management module, and/or a commissioning module. The HCC can include a downstream network interface links, e.g., that link the HHC to one or more lower hierarchy controllers (e.g., local controllers or intermediate controllers of lower hierarchy than the HHC). The HHC can be connected by an upstream network interface to a master controller or any intermediate controller that is in a higher hierarchy than the HHC. The HCC can comprise or be communicatively coupled to a database. FIG. 3 shows an example of a floor controller in which, the HHC 300 includes a protocol conversion module 306, a data logger 307, an analytics module 308, a database manager 309, a tint determination module 310, a power management module 311, and a commissioning module 312. A downstream network interface 305 links HHC 300 to one or more local controllers 303. The HHC 300 connected by an upstream network interface 304 to a master controller 301 and a database 302.

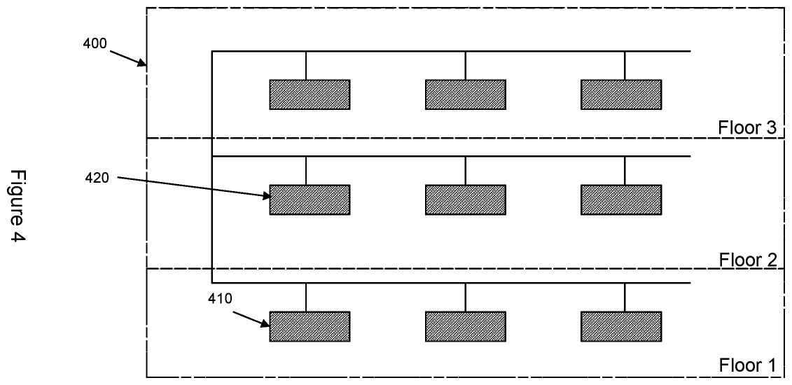

In some embodiments, a plurality of nodes of a processing system may be provided throughout a facility. FIG. 4 shows a schematic example of a processing system (i.e., controller network) in an enclosure. In the example of FIG. 4, the enclosure 400 is a building having floor 1, floor 2, and floor 3. The enclosure 400 includes a network 420 (e.g., a wired network) that is provided to communicatively couple a community of components (e.g., nodes) 410. In the example shown in FIG. 4, the three floors are sub enclosures within the enclosure 400.

In some embodiments, a plurality of installed nodes is commissioned using an automatically performed process (e.g.., autonomously). The nodes can be interconnected as a cluster to form a processing system according to a desired hierarchical scheme and functionality. The nodes may have (e.g., substantially) identical hardware and/or software capabilities, e.g., so that the physical placement and/or interconnection of the nodes into the cluster can be conducted with minimal (e.g., without) manual selection, configuration, and/or assignment requiring foreknowledge of the intended configuration of the processing system. The physical location of any of the nodes may not be important. The self-orchestrating nodes may be communicatively coupled to a local communication link.

In some embodiments, at least one master (e.g., supervisor) node is assigned in a cluster, and at least one slave (e.g., subordinate) node is assigned in a cluster, which slave node may be controlled by the master node. For example, the master can direct one or more requests to the slave node. Assigning the master node may be according to a scheduling and/or organizational scheme (e.g., algorithm). The scheduling scheme may comprise a voting based scheme, circular order (e.g., cyclic executive scheme), randomly, first in—first out (abbreviated herein as “FIFO”), or based on distance from a (e.g., predetermined) anchor. According to the circular order assignment of node may be done in a predetermined order (e.g., circular order) without priority. According to the FIFO scheme (e.g., first come—first served), the first reporting node (e.g., “head” of the queue of node) may be assigned as a master first. According to the circular order scheme (a.k.a., round robin), assignment of node may be done in a predetermined order (e.g., circular order) without priority. The order may be predetermined based on money or more criteria comprising complexity of the cluster (e.g., as disclosed herein), structural aspects(s) of at least a portion of the facility, or functional aspects of at least a portion of the facility. In the random scheme, the master is randomly assigned among nodes in a system. The anchor may be determined based at least in part on a position of a certain client (e.g., device) density of devices in at least a portion of the facility (e.g., enclosure(s) in which the cluster is deployed), structural facility aspect, functional facility aspect, any special point of interest, network related positions (e.g., communication gate to the cloud and/or to the main controller). The anchor may relate to the physical density of at least a portion of the nodes in the facility.

In some embodiments, each node implements an Observer Agent. In some embodiments, the Observer Agents mutually scan for the availability of hosts (e.g., other nodes, including their processing hardware and/or software). The mutual scan can be during initialization (e.g., boot-up) of a processing system and/or at various times during operation. Observer Agents may interact to cooperatively define roles for the discovered hosts. The roles to be assigned can include a Master (i.e., Supervisor) role and a Worker (i.e., Slave) role. In some embodiments, a node assigned to be a Master node may retrieve a service deployment document (e.g., from a Cloud and/or from a node of a higher hierarchy level). The node may (e.g., subsequently) coordinate provisioning of the linked nodes, e.g., as instructed (e.g., defined) in the service deployment document. Provisioning of the linked nodes may be by downloading and installing configuration data and/or software applications. A Master node may take requests from a user and/or from other processing elements, to deploy a work order to a Worker node (e.g., a request to execute a command or to retrieve data). The master node may monitor completion of work orders. A Master node may manage (e.g., distribute) the processing load associated with work orders. In some embodiments, a Worker node controls performance of work tasks of a controlled operating system (e.g., that controls an IGU, HVAC system, or sensor), in response to commands received from a Master node. The commands may be generated in response to predetermined conditions (e.g., by a Master node) or in response to input from a human user. A Worker node may govern intelligent service(s), storage, and/or device configuration. The intelligent service may comprise artificial intelligence (abbreviated herein as “AI”).

In some embodiments, a processing system (also referred herein as a “cluster”) comprises a plurality of nodes. A node can represent any of the controllers in a processing system (e.g., any controller as shown in FIG. 2). The nodes can be communicatively coupled within the cluster, e.g., by a local link. The link can comprise a communication channel (e.g., a network cable such as Ethernet) that can facilitate discoverability of the interconnected nodes. Each node can comprise an observer agent and an orchestrator working together to comprise a self-orchestrating framework. The self-orchestrating framework can handle automatic assignment of roles and overall service deployment. At least one observer agent may operate to define and maintain the roles assigned to each of nodes in cooperation with other observer agent(s). The orchestrator can include an orchestration software application, such as Kubernetes. Other orchestration software may be utilized.

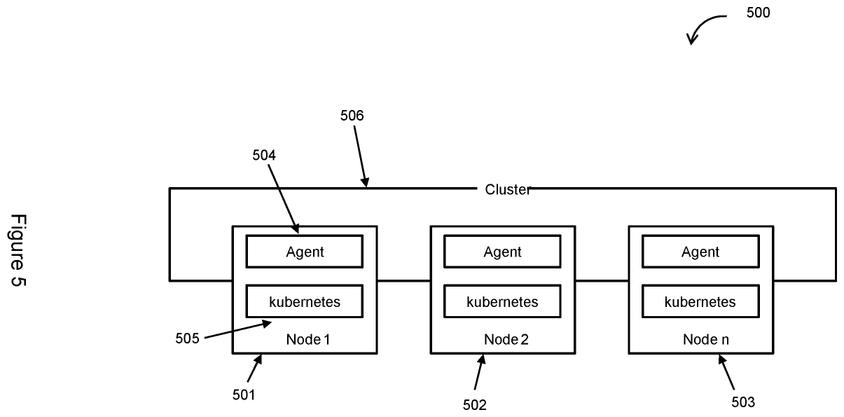

FIG. 5 shows an example of a processing system (e.g., “cluster”) 500 comprising a plurality of nodes 501, 502, and 503. In the example shown in FIG. 5, nodes 501, 502, and 503 are communicatively coupled within cluster 500 by a local link 506. Node 501 comprises an observer agent 504 and an orchestrator 505. Each of the other nodes can similarly comprise a respective observer agent and an orchestrator. Observer agent 504 in cooperation with other observer agents may operate to define and maintain the roles assigned to each of nodes 501, 502, and 503 as described herein.

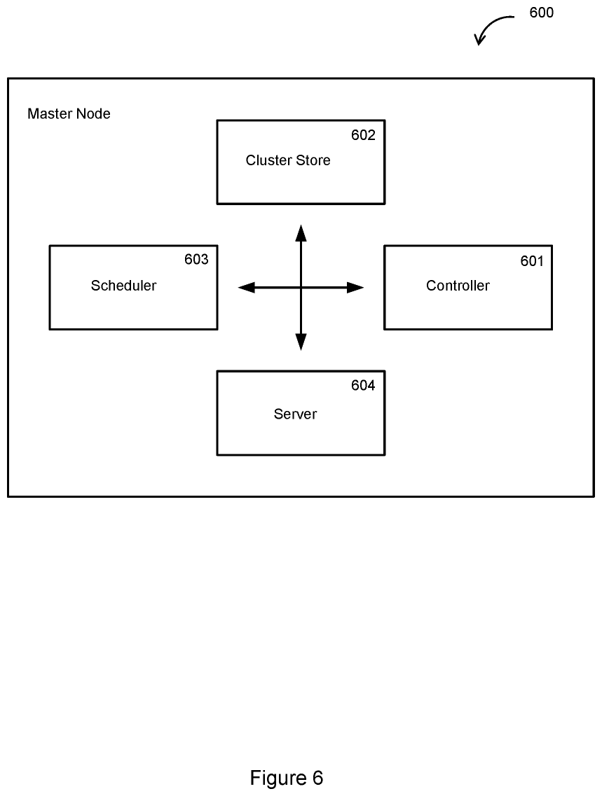

In some embodiments, the orchestrator in any particular node is configured for operating according to a Master role or a Worker (e.g., subordinate) role. In one example, the orchestrators in the plurality of nodes can form a clustered environment that manages containerized applications. The containerized applications can perform various functions such as deployment, scaling, configuration, versioning, and/or rolling updates. In an orchestrator environment (e.g., Kubernetes), a master node may control (e.g., direct and/or monitor) the cluster. The control may include scheduling work, reconfiguring worker nodes, and/or responding to predetermined events. In some embodiments, a Kubernetes master node server to (i) declare application states and/or (ii) maintain a manifest file to validate and/or deploy work orders. The server may include an Application Programming Interface (abbreviated herein as “API”). The server may comprise a web-based server and/or at least one stationary server (e.g., a local server). The stationary server may be in the facility. The stationary server may be in a location other than the facility. The server may comprise one or more publicly exposed endpoints (e.g., to a defined request—response message system). A scheduler (as part of the master node) can track resource utilization, e.g., so that workloads can be balanced. A cluster store (as part of the master node) can replicate orchestration data used across the cluster, e.g., for coordination and/or state management. In some embodiments (such as Kubernetes), a master controller (as part of the master node) fulfills a requested state of the cluster by (i) monitoring the server and/or (ii) adjusting the cluster toward the desired state. FIG. 6 shows an example of a master node 600 in an orchestrated cluster. Master node 600 has a controller block 601, cluster store 602, scheduler 603, and a server 604. The orchestrator (in master and/or in the worker node) can be implemented as a software layer over an infrastructure and/or as a hardware layer, e.g., that is embodied in a controller (e.g., a processing unit).

In some embodiments, a processing unit is included in at least one (e.g., in each) node. The processing unit may be configured to have sufficient computational power for embodying an observer agent and an orchestrator. For example, a node can be a local controller (e.g., a window controller) that, in addition to being provisioned with an observer agent and an orchestrator, is configured to control at least one insulated glass unit (“IGU”). The node can be assigned to have a role of a Master Node or a Worker node. The node can receive and execute downloadable apps for one or more functions and/or services, such as machine learning apps, message brokers, and/or weather prediction. In some embodiments, a local controller (e.g., processing unit) can comprise a window controller, e.g., as disclosed in U.S. Pat. No. 10,533,892, issued Jan. 14, 2020, entitled “MULTI-SENSOR DEVICE AND SYSTEM WITH A LIGHT DIFFUSING ELEMENT AROUND A PERIPHERY OF A RING OF PHOTOSENSORS AND AN INFRARED SENSOR,” that is incorporated herein by reference in its entirety.

In some embodiments, a window controller is generally operable and/or adapted to drive optical state transitions in, or to maintain the optical states of, one or more coupled optically-switchable devices (e.g., electrochromic devices (ECDs)). In some implementations, a processing unit can be implemented with any suitable logic device. The logic device may comprise a processor. The logic device may be configured to perform any of the functions and/or processes described herein. In some implementations, the processing unit comprises a microcontroller (also referred to as a “microcontroller unit” (abbreviated herein as “MCU”)). The processing unit can comprise a microcontroller designed for embedded application(s). For example, the processing unit may include a processor core (for example, a 200 MHz processor core) and a program memory (for example, a 2018 KB or other suitable non-volatile memory), a random-access memory (RAM) (for example, a 512 KB or other suitable RAM), and one or more input-output (abbreviated herein as “I/O”) interfaces. The program memory can include, for example, code executable by the processor core to implement the functions, operations or processes of the processing unit. FIG. 7 shows an example of a local controller 700 in the form of a window controller coupled to an IGU 701 which includes one or more ECDs. Controller 700 has a processing unit 702 interfaced to a network link 703 via a data bus transceiver 704. Link 703 communicatively couples processing unit 702 to other nodes on link 703. In some embodiments, processing unit 702 may be pre-installed with (or be updated with) an observer agent, an orchestrator, and/or one or more software apps.

In some embodiments, a plurality (e.g., all) of the nodes are communicatively coupled. The physical locations of the nodes can be immaterial. In some embodiments, one or more (e.g., all) self-orchestrating nodes are connected via a local link. In some embodiments, one or more (e.g., all) of the nodes can be located at a single facility (e.g., site), or at a single enclosure. The facility and/or enclosure may be accessible via a cloud, and/or remotely. A node may comprise a controller, an actuator, a BMS system (e.g., HVAC system) or be communicatively coupled thereto.

In some embodiments, the plurality of nodes forming a cluster are securely connected (e.g., via a firewall). The cluster may be for a processing system. The secure connection may be communicatively coupled the plurality of nodes to one or more remote resources, e.g., for configuring and/or managing the processing system and the services it performs. For example, the processing system may include an edge service that authenticates the communication to the remote resource(s). The remote resource(s) may include cloud-based remote resource(s). The remote resource(s) may include stationary remote resource(s). the stationary remote resource(s) may be disposed outside of the facility (e.g., in a location different from that of the facility). The edge service can retrieve from a remote location data and/or commands allowing a third party (e.g., a service provider) to define performance parameter(s) and/or configuration(s) for the processing system. The third party may be a central entity. On-site (e.g., manual) configuration and/or customization of the nodes may become unnecessary. In some embodiments, the remote resource(s) include authentication engine(s), service document store(s), container registry(s), and global orchestrator(s) (e.g., a hub for a service provider). The service document store may be a repository for a service deployment document that defines configuration data for the processing system for a particular enclosure (e.g., for a controller network in a particular building). Examples of configuration data include node layout, cardinality, node capabilities (e.g., sensors, actuators, and/or emitters), and/or target application(s). The container registry may store one or more software entities (known as containers) that are used in orchestrating operation of master and worker nodes. The global orchestrator may be responsible for populating the service document store, the container registry, and/or the authentication engine. Population may include customized data, e.g., data corresponding to one or more processing systems such as those of the third party (e.g., one or more customers of the service provider).

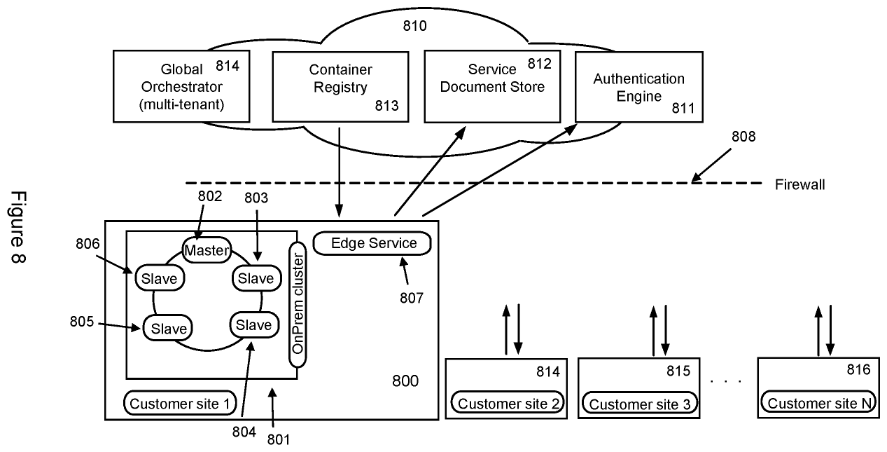

FIG. 8 shows an example of interactions between cloud-based remote resources and one or more processing systems deployed in respective enclosures. Each enclosure may represent a different customer site (e.g., a single customer having a plurality of sites or a plurality of customers having respective sites). In some embodiments, to create a processing system corresponding to a particular facility (e.g., site), a plurality of nodes is installed at the site. In some embodiments, it is sufficient that a pre-configuration of the nodes before installation is limited to include an observer agent and/or an orchestrator. The observer agent may comprise software routine(s) adapted to automatically form a node cluster (e.g., including assignments of master and/or worker nodes). The orchestrator may include software routine(s) adapted to operate a node as a master node or as a worker node. A master node may (e.g., also) operate an edge service. The edge service may be used to configure and/or update a hierarchical controller scheme, e.g., based at least in part on retrieval of a service deployment document and/or containers from a remote resource. In some embodiments, the service deployment document and/or containers are defined by a third party (e.g., service provider). The third party may supply at least one hardware item installed in the building (e.g., an IGU and/or controller node). The third party may supply one or more services including: design, deployment, and/or network services.

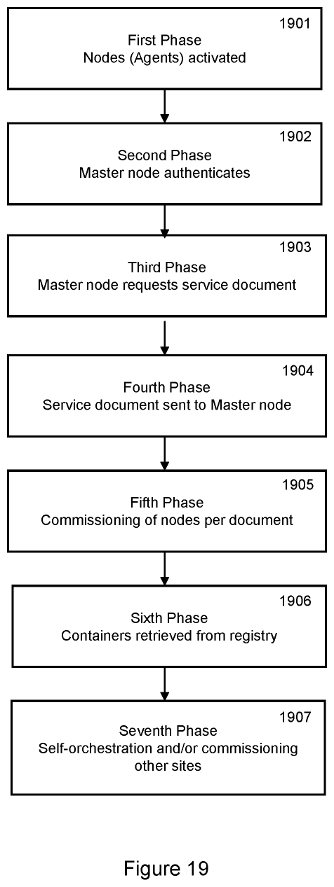

In some embodiments, a customer site is provided with an on-premises cluster having a plurality of nodes (e.g., see FIG. 19). In a first phase of operation, the nodes may be activated such that their observer agents (e.g., automatically) interact to create the cluster. Interact comprises communicate. One or more cluster joining operations may be performed by each node. The cluster joining operations may comprise (e.g., may be) automatic cluster joining operations. The cluster joining operation may be entirely automatic. The cluster joining operations may result in assignments of roles (e.g., as master nodes and/or worker nodes). In some embodiments, a node assigned as a master node (e.g., in the first phase) may proceed to commission the processing system according to a desired configuration. The desired configuration may be defined in at least one service deployment document. In an optional second phase of operation, a master node may use (e.g., pre-configured) credential(s) to authenticate to an authentication engine. The authentication engine may be in a cloud. The authentication may be at least in part via an edge service. A firewall may be used between the site and the cloud, e.g., for enhanced security. A third phase of operation may be conducted wherein the service deployment document(s) is requested by the master node from a document store. The third phase may follow the second phase, or (if no second phase) the third phase may follow the first phase. The service deployment document may be defined using a human-readable data serialization language such as YAML. In a fourth phase, the requested document can be received by the master node, e.g., via the network connection.

In the example shown in FIG. 8, a first customer site 800 has an on-premises cluster 801 including nodes 802, 803, 804, 805, and 806. In one example of a first phase of operation, when nodes 802-806 are activated, their observer agents automatically interact to create the cluster. An automatic cluster joining operation may result in node 802 being assigned a role of master node and nodes 803-806 being assigned a role of worker node. In some embodiments, a node assigned as a master node (e.g., node 802) proceeds to commission the processing system according to a desired configuration defined in at least one service deployment document. In one example of a second phase of operation, master node 802 uses pre-configured credentials to authenticate to authentication engine 811 that resides in a cloud 810 via the edge service 807. A firewall 808 may be used between site 800 and cloud 810 for enhanced security. After authentication, a third phase of operation may be conducted wherein the service deployment document is requested by master node 802 from document store 812. The requested document is received by master node 802 in a fourth phase of operation, e.g., via a network connection.

In some embodiments, a pre-existing cluster may require alteration. As part of the cluster alteration, a fifth phase of operation may be executed. The fifth phase may include using the retrieved service deployment document(s) to commission (e.g., configure and/or re-deploy) one or more of the nodes in the cluster. The cluster alteration may include (i) reconfiguration of one or more of the cluster nodes and/or introduction of one or more new nodes to the cluster. For example, the fifth phase may include reassigning master and worker roles among nodes of the cluster. The reassignment may include a symmetric exchange of roles such that an old worker becomes a new master, and an old master becomes a new worker. The reassignment may include an asymmetric exchange of roles such that an old worker becomes a new master, and an old master is eliminated (e.g., due to malfunction or utilization as a node in another cluster). The cluster alteration can include introducing a new node (e.g., a new master node or a new worker node) to the cluster. The introduction of the new node may be due to malfunction (e.g., failure) of an old node. The introduction of the new node may be with the purpose of increasing a total number of nodes. Increasing the total number of nodes may couple to increasing the number of clients that the nodes serve. The clients may comprise an IGU, a sensor, an emitter, or an antenna. In a sixth phase of operation in some embodiments, the master node retrieves predetermined container(s) from a container registry, e.g., in the cloud. The containers may comprise respective dockers. The containers may be pre-configured to perform respective application functions. Pre-configuring of containers and/or service deployment documents may be controlled by a global orchestrator. In some embodiments, after the master node rolls-out the containers and service deployment document, the processing system has been commissioned and begins to perform the intended functions. In some embodiments, one or more nodes can leave the cluster and/or one or more new nodes can join the cluster. The observer agent(s) and orchestrator(s) (i) may continue to monitor for any changes, (ii) may generate new role assignment(s) and/or (iii) may configure (or reconfigure) node(s) on an ongoing basis. In some embodiments, a seventh phase of operation includes separate commissioning at other customer sites.

FIG. 8 shows an example in which the master node retrieves (e.g., predetermined) container(s) from a container registry 813 in cloud 810 during the sixth phase of operation. Pre-configuring of container(s) and/or service deployment document(s) can be controlled, e.g., by global orchestrator 814. After the master node implements the container(s) and service deployment document(s), nodes 802-806 perform their intended functions (e.g., directing any clients communicatively coupled to these nodes). In some embodiments, the observer agent(s) and orchestrator(s) (i) continue to monitor for any change, (ii) may make new role assignments, and/or (iii) may configure or reconfigure nodes, e.g., on an ongoing basis. In the example of FIG. 8, other customer sites 814, 815, and 816 can be commissioned (e.g., in a similar manner) during the seventh phase of operation. At least two customer sites may be commissioned simultaneously. At least two customer sites may be commissioned sequentially. There may be a time overlap in commissioning at least two customer sites.

FIG. 19 shows an example of operational phases. The operational phases can relate to a business model that could be used by a service provider. In a block 1901, a first phase includes activation (e.g., boot-up) of nodes in a cluster. Upon activation, the observer agents in the nodes (e.g., one observer agent per node) interact such that at least one node (e.g., each node) node joins the cluster and an (alpha) master node is determined. In block 1902, the (alpha) master node authenticates to a cloud-based server (e.g., in a service center of a service provider) in a second phase. In block 1903, a third phase includes a request from the master node to receive a service deployment document for the activated cluster. In block 1904, the service document is sent to the master node in a fourth phase. In block 1905, a fifth phase of operation includes the commissioning of nodes in the cluster by the master node, e.g., according to the service document. In a block 1906, the master node and/or the commissioned nodes themselves may retrieve one or more containers (e.g., application software) from a registry. The registry can be located remotely, e.g., in the cloud service. As part of an overall service which may span a plurality of enclosures (e.g., buildings) for a common customer, a seventh phase of operation in a block 1907 includes the self-orchestration and/or commissioning of other clusters (e.g., in coordination with the first cluster). One or more of these operation phases may be optional phases. For example, any of the third phase to seventh phase may be optional phases.

In some embodiments, the first phase of operation is triggered when a plurality of nodes has been installed in an enclosure, connected together by a local network link, and powered on. A system boot-up process may be automatically launched in each node, e.g., when a respective observer agent in each node executes a method leading to all the nodes joining the cluster. The joining process may include assigning master and worker roles to the joined nodes. In some embodiments, one or more nodes are first established as having the master role. Once at least one master node is established, the hierarchy of the cluster can be initialized. Subsequently, other nodes may be permitted to join the cluster (e.g., in a worker role), e.g., by submitting a join request to the master node.

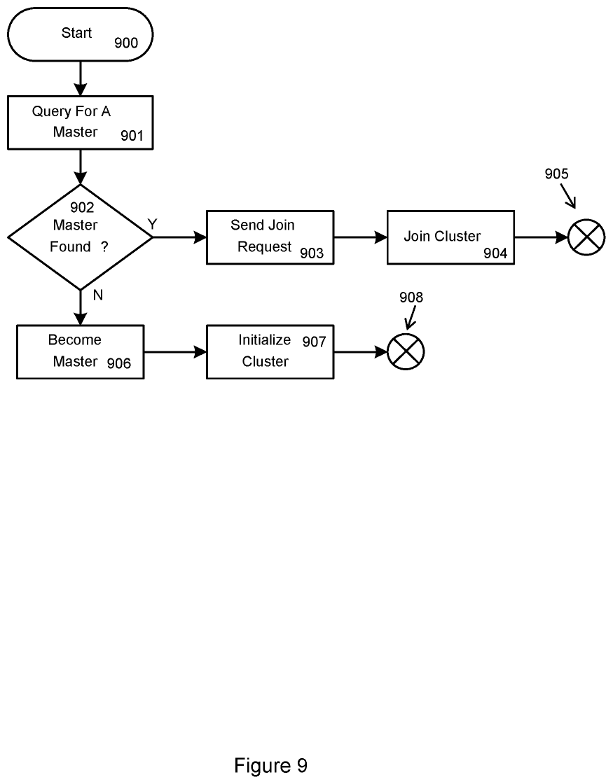

FIG. 9 shows an example wherein a SystemBootUp routine starting at block 900 may be executed by observer agents. In block 901, a query is broadcast by an observer agent to inquire whether any other observer agent on the local link has already been assigned a role of master. In some embodiments, the query can be sent, e.g., using a message queue. The message queue may utilize a zero configuration service (e.g., using Multicast Domain Name System (abbreviated herein as “MDNS”) protocol and/or Domain Name System Service Discovery (abbreviated herein as “DNS-SD”). The observer agent can wait for a response, e.g., for a predetermined time. In the example shown in FIG. 9, a check is performed in block 902 to determine whether a response identifying a master node has been received. If received, the observer agent sends a join request 903 to the identified master node. The observer agent performs a cluster join operation via the master node in block 904 (e.g., as a worker node). After joining, the node may proceed to orchestrated operation at block 905. In the event that no master node responded at block 902, the observer agent can assume the role of master in block 906. Operating as a master node, the observer agent initializes the cluster in block 907. Initialization may include compiling a directory of nodes in the cluster and commissioning the nodes according to a service deployment document that can be retrieved by the master node. After commissioning, the node proceeds to orchestrated operation at block 908.

In some embodiments, enhanced coordination between nodes is provided, e.g., by making one or more additional assignments of the master role. These embodiments may comprise large clusters with nodes that are communicatively coupled (e.g., connected together by corresponding network links). The clusters may comprise at least 2, 3, 5, 10, 50 or 100 nodes. The clusters may comprise any number of nodes between the aforementioned nodes in a cluster (e.g., from 2 to 100, from 2 to 10, or from 10 to 100, nodes in a cluster). The large clusters may comprise at least 101, 250, 500, 750, 1000, 5000, or 10000 nodes. The large clusters may comprise any number of nodes between the aforementioned nodes (e.g., from 101 to 10000, from 101 to 1000, or from 1000 to 10000, nodes in a large cluster). Whether one or more than one master node assignment is being made, it may be beneficial in some examples to handle possible contention between nodes for obtaining status as a master. In some embodiments, an observer agent that broadcasts a claim to be a master continues to monitor for other such claims (coming through the communication network) for a given time. The observer agent may continue to broadcast its claim to be a master during the wait time. When no other contention is detected, the node broadcasting its claim to be a master may assume the master role. When contention by another node is detected, a contest procedure may initiate. The contest procedure may comprise an initiation of another round of broadcasting of claims to be a master node. During the new round, to reduce the likelihood of ongoing contentions the contending nodes may wait random wait times before broadcasting their claim to be a master node. The first node to place a claim for the master node on the network may assume the master role.

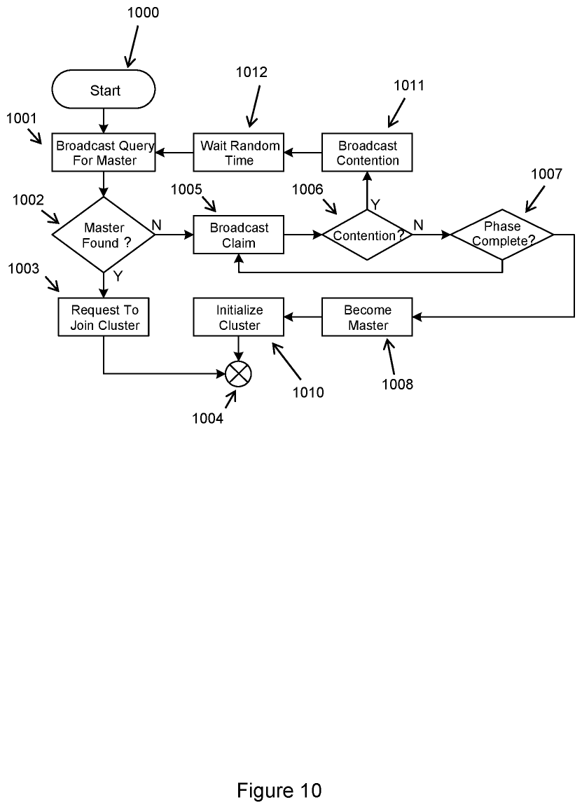

FIG. 10 shows an example process followed by each observer agent for seeking to obtain a master role. The process starts at block 1000. Upon booting up, the observer agent broadcasts a query in block 1001 to inquire whether any other observer agent on the local link has already been assigned a role of master. In some embodiments, the query can be sent. The observer agent waits for a response, e.g., for a predetermined time. A check is performed in block 1002 to determine whether a response identifying a master node has been received. If so, then the observer agent sends a join request to the identified master node in block 1003 (e.g., as a worker node). After joining, the node proceeds to orchestrated operation at block 1004.

In the event that no master node responded at block 1002, the observer agent broadcasts a claim to assume the master role at block 1005. At block 1006, the observer agent monitors for broadcasts from any other node that may also assert a claim to the master role (i.e., a contending claim). If no contention is detected, then a check is performed in block 1007 to determine whether a contention phase is complete. Completion of the contention phase may, for example, be comprised of the expiration of a predetermined time. If the phase is complete, then the assertion of the master role is successful in block 1008. The master node initializes the cluster in block 1010. If the phase is not complete, then the claim as a master is repeated in block 1005. If a contending claim is detected at block 1006, then the observer agent broadcasts a message (e.g., a negative acknowledgement). The message informs the other nodes that the contention has occurred. Broadcasting of the contention message cancels all pending assertions to become a master node. After waiting a random amount of time in block 1012, the observer agent returns to block 1001 to broadcast a new query for an existing master. Since each of the formerly contending nodes waits a different random time to continue, it is likely that the claims to obtain the master role will not recur at the same time. One of the observer agents will have randomly a shortest wait time, allowing it to first establish a master role as a response to the query (e.g., of block 1001). The query can be broadcasted by at least one node in the network (e.g., when the node does not find a master).

In some embodiments, more than one node is designated as a master node. When there is more than one master, one of the masters may be designated as an alpha or first master. The masters may operate in a coordinated manner to share responsibilities of the master role. In another example, the alpha master can carry the sole responsibility with the other masters acting as backups. A cardinality (i.e., number of nodes) for each role (e.g., master and worker) may be determined and used by a master node when forming and configuring the cluster. A master node may check to determine whether it is the first (alpha) master. When it finds that it is the first master, then the node may apply the deployment specification (e.g., commissions the other nodes according to the roles/functions defined in the deployment specification). If not the first master node, then the node continues to operate as a master node without applying the deployment document. The master node may control work orders to working nodes (e.g., substance, execution, and/or flow of the work orders).

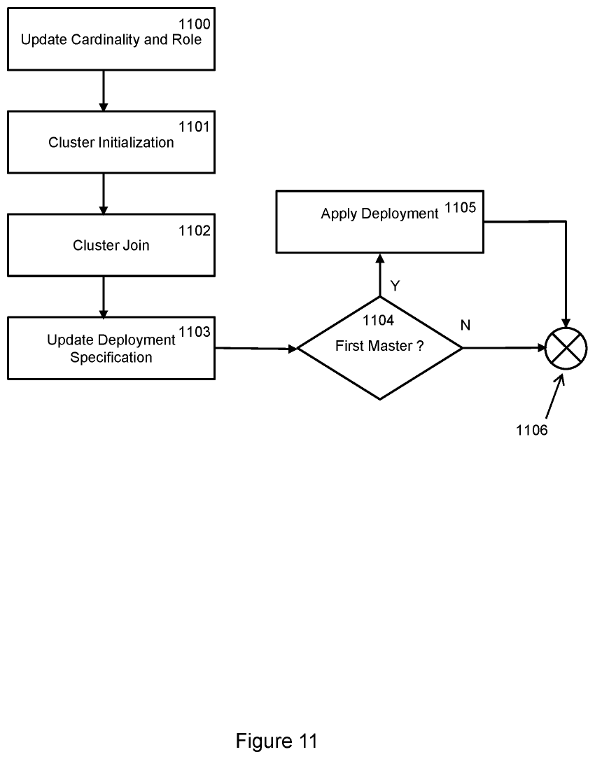

FIG. 11 shows an example of a process of cluster formation and commissioning in a master node. In block 1100, a node finalizes its assignment as a master and updates its count for the cardinality of the cluster. The node initializes the cluster at block 1101. In response to requests from other nodes, the master node allows the other nodes to join as a worker node, or sometimes as another master node (e.g., depending the foreseen cluster complexity), in block 1102. The master node retrieves the deployment specification (e.g., service deployment document) in block 1103. For example, the retrieval may utilize an edge service to access a cloud. In block 1104, the node checks whether it is the first (alpha) master. If it is not first, then orchestrated operation proceeds at block 1106. If it is first, then the node applies the deployment specification (e.g., commissions the other nodes according to the roles/functions defined in the deployment specification). Then orchestrated operation proceeds at block 1106. The cluster complexity may depend at least in part on a total number of nodes in the cluster, type(s) of clients serviced by the nodes, type(s) of assignments directed to the clients, and/or size of the facility.

In some embodiments, additional new nodes are connected to an existing cluster after initial commissioning and normal orchestration operation is established. For example, a new node can be permitted to join the cluster and to receive a corresponding role as required and/or permitted by the cluster. When the new node is communicatively linked to the cluster (e.g., and when it is powered up), its observer agent may boot up and generate a join request. An existing master node may receive the join request and may determine whether the new node should be added as a worker node or as another master node. In some embodiments, there may be at most 1, 3, 5, 7, or 9 master nodes. For example, when a total number of nodes in a cluster is or becomes greater than a threshold number (e.g., five), then any number of nodes below the threshold number of nodes may be assigned to be master nodes. In some embodiments, a number (cardinality) of master nodes is selected to be an odd number. An odd number of master nodes facilitates resolving conflicts (e.g., breaking a tie) during a contest of nodes requesting to become a master node (e.g., a contest procedure as described herein), and/or when master nodes are sharing control of a processing system and generate conflicting actions.

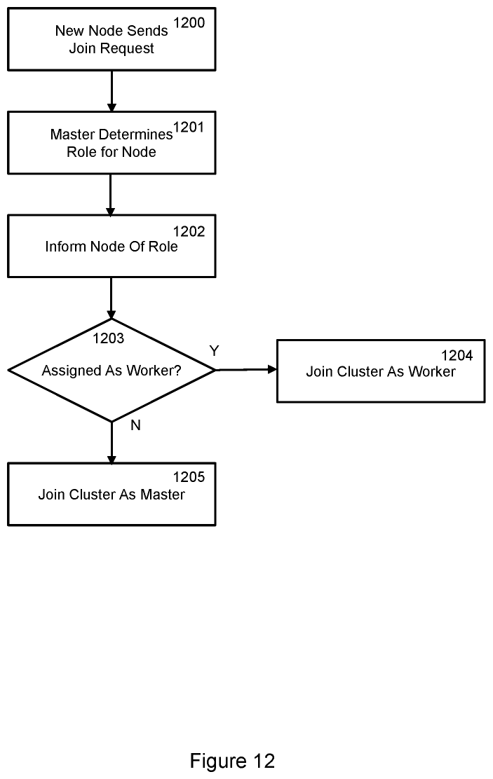

In some embodiments, commissioning that occurs when adding a new node includes assignment of a worker node to an existing master node, assignment of a worker node to a particular client (e.g., a device such as an IGU), and/or assignment of a (e.g., additional) master node. Nodes can, for example, be added in a plug and play fashion, resulting in automated horizontal scaling. FIG. 12 shows an example of a process for adding a new node to an existing cluster. In block 1200, the new node broadcasts a join request over the link that interconnects the cluster. A master node receiving the join request determines a role to be assigned to the node (e.g., a master node or a worker node). The determination can comprise comparing a total node count (cardinality) with one or more thresholds which correlate to the number of master nodes that are needed for the cardinality. If the added node results in reaching the threshold, the new node (e.g., and possibly one or more preexisting worker nodes) can be assigned to have a master role. In block 1202, the master node transmits a message to the new node to inform the new node of its selected role. In block 1203, the new node checks whether it was assigned to be a worker node. If so, then the new node joins the cluster as a worker node in block 1204. Otherwise, the new node joins the cluster as a master node in block 1205.

In some embodiments, assignments of a role to one or more nodes occurs during initial installation, upon addition of new nodes, and/or upon departure (e.g., failure or removal) of one or more nodes from a cluster. For example, an observer agent in a master node or a worker node can monitor activity of other nodes. The observer agent can infer malfunctioning of a node that remains silent for a predetermined time and/or that fails to respond to direct queries. By automatically reassigning roles upon detection of a failure, the resiliency of the processing system is improved, e.g., since occurrence of a single point of failure can be reduced (e.g., avoided). A master node (e.g., a supervisory node) can be assigned, replaced (e.g., switched), or the numbers of master nodes increased, such as for resiliency purpose. In some embodiments, the assignment and/or selection of nodes is done using a stochastic model. In some embodiments, a manual override is used to replace a stochastic distribution (e.g., for supervisor assignment). In some embodiments, the initial setup of the nodes is stochastic, while reassignment of masters is non-stochastic. In some embodiments, the initial setup of the nodes is non-stochastic, while reassignment of masters is stochastic. In some embodiments, when a worker node realizes it has no master (e.g., when the cluster loses at least one master), then a new master is assigned. In one example, the worker node first detecting the loss of a master can become the new master. In an example, the worker node in a cluster can ask for a new master to be assigned from other available masters in the cluster. In an example, a master can be temporarily assigned from the cloud. In an example, the worker node may function without a master temporarily (e.g., for a limited time, that can be pre-determined) while the overall system assigns and/or requests another master assignment. The processing system may have redundancy (e.g., of supervisor nodes and/or of worker nodes). The processing system can have backup master nodes, e.g. worker nodes with instructions to become master nodes upon at least one triggering event. A triggering event can comprise a master leaving the system due to malfunction, maintenance, or increase in the cluster complexity (e.g., as disclosed herein). The processing system can be fully or partially redundant. For example, the system may have at least partial master node redundancy. For example, the system may have at least partial worker node redundancy. The system may have redundancy depending on the importance (i) of a facility or any section (e.g., rooms) thereof, and/or (ii) of network section(s).

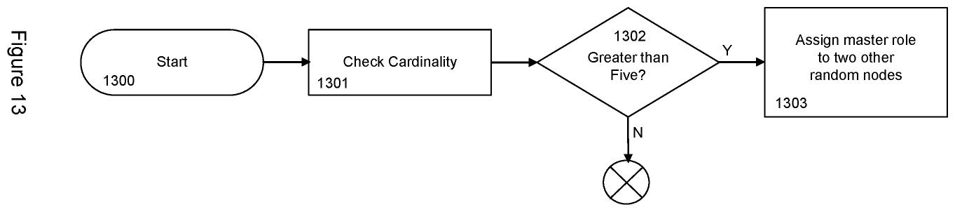

FIG. 13 shows an example of a stochastic method for assigning the master role (e.g., when a node leaves or a new node joins the cluster). The process starts at block 1300 and proceeds to check cardinality in block 1301. A check is performed at block 1302 to determine whether the cardinality (e.g., node count) is greater than a threshold. If not, then the process exits without changing a master role. If a new node has joined, then it is assigned the worker role. If cardinality is greater than the threshold, then an existing master node can assign (e.g., promote) the master role to at least one more (e.g., randomly or non-randomly chosen) worker nodes in block 1303, with the number of new master roles assignment depending on the threshold.

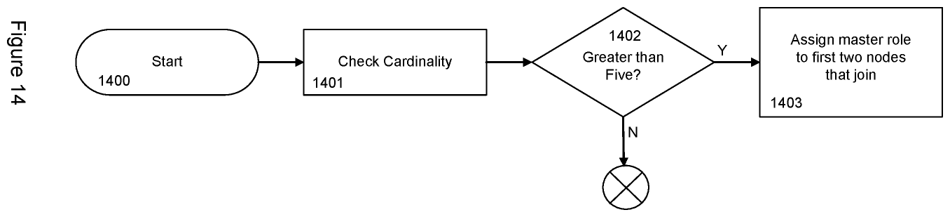

FIG. 14 shows an example of a method for assigning the master role according to a time sequence (e.g., when a node leaves or a new node joins the cluster). The process starts at block 1400 and proceeds to check cardinality in block 1401. A check is performed at block 1402 to determine whether the cardinality (e.g., node count) is greater than five (the number five is provided as a master node threshold value in this example). If not, then the process exits without changing a master role. If a new node has joined, then it is assigned the worker role. If cardinality is greater than the threshold value (in this example, five), then an existing master node can assign (e.g., promote) the master role to two other existing worker nodes in block 1403. In an example, the chosen worker nodes can be selected in sequential order from a list. The list can be compiled according to the times at which respective nodes joined the cluster. If the end of the list is reached without finding available nodes for the assignments, the process may wait at block 1403 until an additional node joins the cluster.

In some embodiments, a voting method may be used to resolve a contest of nodes. (e.g., to conduct a contest procedure). In some embodiments, the master role is assigned according to a voting method. The voting method could be invoked in a cluster during initial boot-up. The voting method could be invoked in a cluster when nodes leave and/or joins a cluster having one or more existing master node assignments. For example, when there is one master node and an additional node joins a cluster, the cardinality can be checked to determine whether a threshold is reached. Reaching the threshold may trigger allowance (e.g., and subsequent formation of) a greater number of master nodes. When it is determined that a master node should be added, then a voting process may be utilized. The voting process may include a solicitation message, e.g., that is broadcasted (e.g., by the observer agent in the master node) to the nodes in the cluster. Each node may be programmed to respond to a solicitation message, e.g., when a (e.g., predetermined) processing capacity is available on the node. If a number of nodes respond than are needed, which number of nodes is greater than the threshold, then the master node may make a selection. The selection may be done randomly. The selection may be using criteria such as type of node or processing capacity. The selection may employ any selection criteria and/or scheme disclosed herein, e.g., any scheduling and/or organizational scheme.

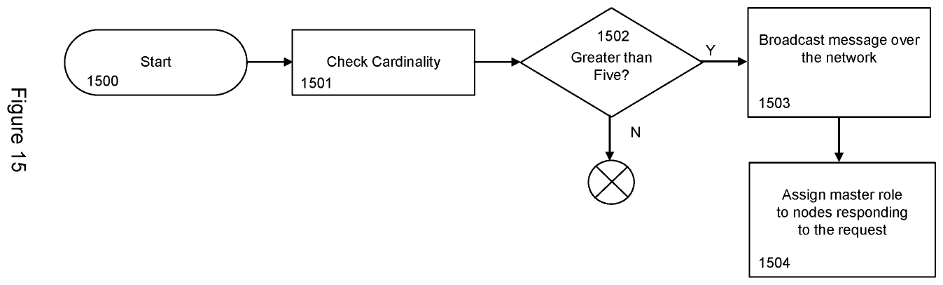

FIG. 15 shows an example of a method for assigning the master role according to a voting method (e.g., when a node leaves or a new node joins the cluster). The process starts at block 1500 and proceeds to check cardinality in block 1501. A check is performed at block 1502 to determine whether the cardinality (e.g., node count) is greater than the threshold (e.g., five). If not, then the process exits without changing a master role. If a new node has joined, then it is assigned the worker role. If cardinality is greater than the threshold, then an existing master node can assign (e.g., promote) the master role to any remaining number of available master node roles below the threshold, for any other existing worker nodes. In block 1503, a message is broadcast to the cluster over the local network link to solicit a response from any nodes that would be capable of assuming the master role. For example, a worker node having sufficient spare processing capacity may respond to the message. The existing master node may assign the master role in block 1504 to two worker nodes that respond to the message. If an insufficient number of nodes respond to the message, then the existing master can make a new assignment of the master role on the basis of a random selection, for example.

In some embodiments, the observer agents are in continuous operation in order to maintain appropriate numbers of master nodes and to adjust when nodes join or leave a cluster. In one example, adjustment of roles to ensure sufficient numbers of master nodes may be triggered by a segregation of an existing cluster into two or more different clusters. For example, occupancy in a building or portion of a building formerly occupied by one customer may be subdivided so that a portion becomes occupied by a different customer. For example, the number of clients (e.g., devices) supported by a cluster increases a size that the cluster can (e.g., reliably) handle. The local network link may be severed at a point that isolates separate the cluster to sub clusters. The separation of the cluster to sub clusters may be according to the spaces occupied by the different customers. This may be conducted for the purpose of maintaining security and/or confidentiality between the different customers. The separation of the cluster to sub clusters may be according to the complexity of the cluster (e.g., when clients and/or node numbers increase beyond a threshold). This may be conducted for the purpose of maintaining reliable and/or safe operation of the cluster. A safe operation may be execution of cluster operation (e.g., control) without collapse of the cluster. A safe operation may depend on jurisdictional requirements (e.g., ensuring health and safety of occupants in the facility). In response to dividing the cluster into sub clusters, the observer agents may (e.g., automatically) adjust roles within each sub cluster as necessary.

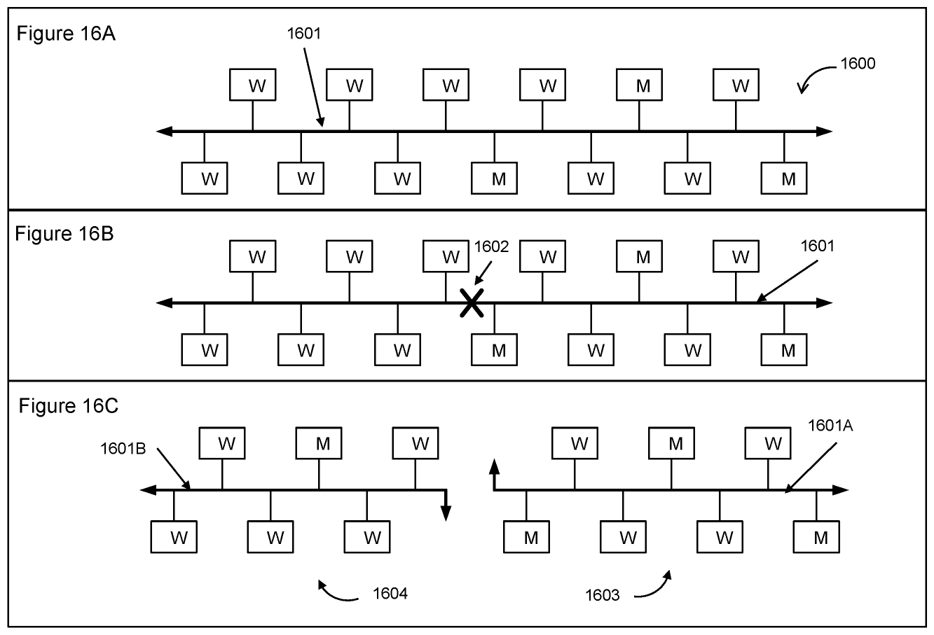

FIG. 16A shows an example in which a cluster 1600 in interconnected by a local network link 1601. A plurality of nodes is connected to communication link 1601. Each node is designated according to a role of master (indicated by the letter “M”) or worker (indicated by the letter “W”). In FIG. 16B, communication link 1601 is being severed at a point 1602 along the link that isolates the network into two sub clusters that no longer communicate with each other. Severing the communication link can be physical (cutting or disconnecting a cable) or virtual (e.g., a software block). As shown in FIG. 16C, a sub cluster 1603 is interconnected by a local link 1601A and a sub cluster 1604 is interconnected by a local link 1601B. Prior to the separation, the nodes included in sub cluster 1604 were all worker nodes. After segregation, the observer agents operate to promote at least one worker node in sub cluster 1604 to be a master node.

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

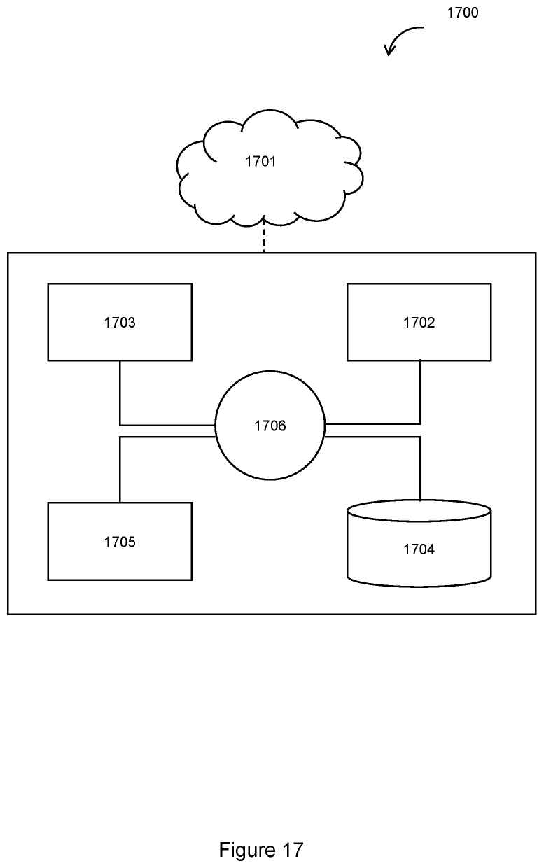

FIG. 17 shows a schematic example of a computer system 1700 that is programmed or otherwise configured to one or more operations of any of the methods provided herein. The cluster may comprise a computer system. For example, a node may comprise a circuitry (e.g., processor). For example, a node may comprise a logical device (e.g., processor). The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 1706) (also “processor,” “computer” and “computer processor” used herein). The computer system may include memory or memory location (e.g., 1702) (e.g., random-access memory, read-only memory, flash memory), electronic storage unit (e.g., 1704) (e.g., hard disk), communication interface (e.g., 1703) (e.g., network adapter) for communicating with one or more other systems, and peripheral devices (e.g., 1705), such as cache, other memory, data storage and/or electronic display adapters. In the example shown in FIG. 17, the memory 1702, storage unit 1704, interface 1703, and peripheral devices 1705 are in communication with the processing unit 1706 through a communication bus (solid lines), such as a motherboard. The storage unit can be a data storage unit (or data repository) for storing data. The computer system can be operatively coupled to a computer network (“network”) (e.g., 1701) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or as a server.

The processing unit can execute a sequence of machine-readable instructions, which can be embodied in a program or software. The instructions may be stored in a memory location, such as the memory 1702. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1700 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The processing unit (e.g., computer system) can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user can access the computer system via the network. The processing unit may comprise a CPU or a GPU. The processing unit may comprise a media player. The processing unit may be included in a circuit board. The circuit board may comprise a Jetson Nano™ Developer Kit by NVIDIA®, (e.g., 2 GB or 4 GB developer kit) or Raspberry-Pi kit (e.g., 1 GB, 2 GB, 4 GB, or 8 GB developer kit). The processing unit may be operatively coupled to a plurality of ports comprising at least one media port (e.g., a DisplayPort, HDMI, and/or micro-HDMI), USB, or an audio-video jack, e.g., that may be included in the circuit board. The processing unit may be operatively coupled to a Camera Serial Interface (CSI), or a Display Serial Interface (DSI), e.g., as part of the circuit board. The processing unit is configured to support communication such as ethernet (e.g., Gigabit Ethernet). The circuity board may comprise a Wi-Fi functionality, a Bluetooth functionality, or a wireless adapter. The wireless adapter may be configured to comply with a wireless networking standard in the 802.11 set of protocols (e.g., USB 802.11ac). The wireless adapter may be configured to provide a high-throughput wireless local area networks (WLANs), e.g., on at least about a 5 GHz band. The USB port may have a transfer speed of at least about 480 megabits per second (Mbps), 4,800 Mbps, or 10,000 Mbps. The at least one processor may comprise a synchronous (e.g., clocked) processor. The clock speed of the processor may be of at least about 1.2 Gigahertz (GHz), 1.3 GHz, 1.4 GHz, 1.5 GHz, or 1.6 GHz. The processing unit may comprise a random access memory (RAM). The RAM may comprise a double data rate synchronous dynamic RAM (SDRAM). The RAM may be configured for mobile devices (e.g., laptop, pad, or mobile phone such as cellular phone). The RAM may comprise a Low-Power Double Data Rate (LPDDR) RAM. The RAM may be configured to permit a channel that is at least about 16, 32, or 64 bit wide.

Methods as described herein can be implemented by way of machine (e.g., computer processor) executable code stored on an electronic storage location of the computer system, such as, for example, on the memory 1702 or electronic storage unit 1704. The machine executable or machine-readable code can be provided in the form of software. During use, the processor 1706 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, a client comprises a device. The device may be controlled by the processing system. The device may include a tintable window in an insulated glass unit (“IGU”). The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g. connect) one or more electrochromic devices to a voltage source, switches and the like, and may include a frame that supports the IGU or laminate. A window assembly may include a window controller, and/or components of a window controller (e.g., a dock).

In some implementations, the first and the second panes are transparent or translucent, e.g., at least to light in the visible spectrum. For example, the first pane and/or second can comprise a hardened material that is at least partially transparent in the visual spectrum. The hardened material may be a polymer or a resin. The hardened material may be an organic polymer. The hardened material may be glass. For example, the first pane and/or second pane (e.g., lite) can be formed of a glass material. The glass material may include architectural glass, and/or shatter-resistant glass. The glass may comprise a silicon oxide (SOₓ). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

In various embodiments, a network infrastructure supports a control system for one or more windows such as electrochromic (e.g., tintable) windows. The control system may comprise one or more controllers operatively coupled (e.g., directly or indirectly) to one or more windows. While the disclosed embodiments describe electrochromic windows (also referred to herein as “optically switchable windows,” “tintable windows”, or “smart windows”), the concepts disclosed herein may apply to other types of switchable optical devices including, for example, a liquid crystal device, or a suspended particle device. For example, a liquid crystal device and/or a suspended particle device may be implemented instead of, or in addition to, an electrochromic device.

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD, or “EC” device). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g., noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD)

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g. cations) into the oxide may induce a visible change in a tint (e.g., color) of the oxide. For example, the oxide may transition from a colorless to a colored state. For example, intercalation of lithium ions into tungsten oxide (WO3-y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

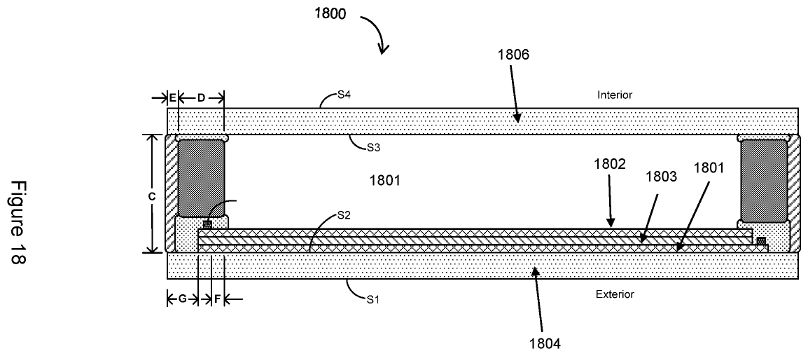

FIG. 18 shows an example implementation of an IGU 1800 in accordance with some embodiments that includes a first pane 1804 having a first surface S1 and a second surface S2. In some implementations, the first surface S1 of the first pane 1804 faces an exterior environment, such as an outdoors or outside environment. The IGU also includes a second pane 1806 having a first surface S3 and a second surface S4. In some implementations, the second surface (e.g., S4) of the second pane (e.g., 1806) faces an interior environment, such as an inside environment of a home, building, vehicle, or compartment thereof (e.g., an enclosure therein such as a room). An electrochromic (EC) device is attached to surface S2, and may comprise an electrochromic layer (EC) or stack 1803 (which may include a cathodically coloring layer or a cathodically tinting layer together with an ion conducting layer or region (IC) and a counter electrode layer (CE)) between a first transparent conductive layer (TCL) 1801 and a second TCL 1802.

A voltage source may be operably connected to apply an electric potential across the electrochromic stack 1803 to effect transitions of the electrochromic coating from, e.g., a clear state to a tinted state. In other embodiments, the order of layers is reversed with respect to the substrate. That is, the layers can be in the following order: substrate, TCL, counter electrode layer, ion conducting layer, electrochromic material layer, TCL.

In some embodiments, the ion conductor region forms from a portion of the EC layer and/or from a portion of the CE layer. The electrochromic stack may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725 filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 1803. Various layers, including transparent conducting layers (such as 1801 and 1802), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack such that available ions in the stack that can cause the electrochromic material to be in the tinted state reside primarily in the counter electrode when the window is in a first tint state (e.g., clear). When the potential applied to the electrochromic stack is reversed, the ions can be transported across the ion conducting layer to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., untinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to untinted state).

In certain embodiments, at least a portion (e.g., all of) the materials making up electrochromic stack are inorganic, solid (i.e., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The sensor may be configured to differentiate based on depth (e.g., a depth camera). The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, charged coupled device (CCD) camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, radar, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for deployment of at least one work order in a local network of a facility, the method comprising:
(a) activating a plurality of nodes as observer agents, which plurality of nodes forms a cluster, which plurality of nodes is disposed in a facility and are operatively couped to the local network of the facility;
(b) using an observer agent of the observer agents to broadcast a query to the cluster and wait for a response, which query inquires whether any of the plurality of nodes is assigned a role of a Master Node;
(c) if the observer agent does not receive a positive response to the query, assigning (i) the role of the Master Node to the observer agent and (ii) a role of a Worker Node to any node of the plurality of nodes different from the Master Node to form at least one Worker Node; and
(d) using the Master Node to (I) retrieve at least one work order and (II) orchestrate the at least one work order among any of the at least one Worker Node.

2. The method of claim 1, wherein the Master Node deploys the at least one work order to the at least one Worker Node.

3. The method of claim 1, wherein the at least one Worker Node is communicatively coupled to at least one device disposed in the facility, and wherein the at least one work orders includes one or more commands for operating the at least one device.

4. (canceled)

5. The method of claim 1, wherein the network is configured to transmit communication and power on one cable.

6.-8. (canceled)

9. The method of claim 1, wherein a plurality of observer agents assigns the role of Master Node to more than one node of the plurality of nodes to form a plurality of Master Nodes, and wherein the plurality of Master Nodes handles deployment of work orders.

10. The method of claim 9, wherein the plurality of Master Nodes handles deployment of work orders communally.

11. The method of claim 9, wherein the plurality of Master Nodes handles deployment of work orders hierarchically.

12. The method of claim 9, wherein a first Master node of the plurality of Master Nodes handles deployment of a first group of work orders, and a second Master node of the plurality of Master Nodes handles deployment of a second group of work orders.

13. The method of claim 12, wherein the first group of work orders and the second group of work orders differ in their order timing, deployment timing, device type they target, and/or device location they target.

14. The method of claim 1, wherein the assignment of the Master Node is at least in part according to (a) one or more assertions made by the Master Node and (b) a time order in which the one or more assertions occur.

15. The method of claim 1, wherein the Master Node is a first Master Node, and wherein the observer agent is a first observer agent, wherein the query is a first query, and wherein the method further comprises using a second observer agent of the observer agents to broadcast a second query to the cluster that at least partially overlaps in time broadcasting of the first query, which second query inquires whether any of the plurality of nodes is assigned a role of a Master Node.

16. The method of claim 1, further comprising:
(A) determining a number of nodes that comprises the cluster; and
(B) if the number exceeds a threshold then promoting a role of at least one Worker Node to the role of Master Node.

17. The method of claim 16, wherein a total number of Master Nodes after promoting the Worker Nodes is an odd number.

18. The method of claim 16, wherein the Worker Node promoted is selected randomly.

19. The method of claim 16, wherein a plurality of Worker Nodes is promoted to the role of Master Node, and wherein the promoted Worker Nodes are selected from Worker Nodes that respond to a broadcast message sent by an observer agent.

20. The method of claim 1, further comprising the Master Node initializing the cluster.

21. Apparatus for deployment of at least one work order in a local network of a facility, comprising a plurality of nodes (i) that forms a cluster, (ii) that is disposed in a facility, (iii) that is operatively couped to a local network of the facility, (iv) that comprise circuitry, and (v) is configured to:
(a) activate the plurality of nodes as observer agents;
(b) use an observer agent of the observer agents to broadcast a query to the cluster and wait for a response, which query inquires whether any of the plurality of nodes is assigned a role of a Master Node;
(c) if the observer agent does not receive a positive response to the query, assign (i) the role of the Master Node to the observer agent and (ii) a role of Worker Node to any node of the plurality of nodes different from the Master Node to form at least one Worker Node; and (d) use the Master Node to (I) retrieve at least one work order and (II) orchestrate the at least one work order among any of the at least one Worker Node.

22. The apparatus of claim 21, wherein the apparatus is configured so that the Master Node deploys the at least one work order to the at least one Worker Node.

23. The apparatus of claim 21, wherein the apparatus is configured so that the at least one Worker Node is communicatively coupled to at least one device disposed in the facility, and wherein the at least one work orders includes one or more commands for operating the at least one device, and the at least one device is included in a device ensemble comprising sensors or a sensor and an emitter.

24.-28. (canceled)

29. The apparatus of claim 21, wherein the apparatus is configured so that a plurality of observer agents assigns the role of Master Node to more than one node of the plurality of nodes to form a plurality of Master Nodes, and wherein the plurality of Master Nodes handles deployment of work orders.

30. The apparatus of claim 21, wherein the apparatus is configured so that the assignment of the Master Node is at least in part according to (a) one or more assertions made by the Master Node and (b) a time order in which the one or more assertions occur.

31. The apparatus of claim 21, wherein the apparatus is configured so that the Master Node is a first Master Node, and wherein the observer agent is a first observer agent, wherein the query is a first query, and wherein a second observer agent of the observer agents broadcasts a second query to the cluster that overlaps in time broadcasting of the first query, which second query inquires whether any of the plurality of nodes is assigned a role of a Master Node.

32. The apparatus of claim 21, wherein the apparatus is configured to:
(A) determine a number of nodes that comprises the cluster; and
(B) if the number exceeds a threshold then promote a role of at least one Worker Node to the role of Master Node.

33.-38. (canceled)

39. A non-transitory computer program product for deployment of at least one work order in a local network of a facility, which non-transitory computer program product contains instructions inscribed thereon which, when executed by one or more processors, cause the one or more processors to execute operations, comprising:
(a) activating a plurality of nodes as observer agents, which plurality of nodes form a cluster, which plurality of nodes is disposed in a facility and is operatively couped to the local network of the facility;
(b) using an observer agent of the observer agents to broadcast a query to the cluster and wait for a response, which query inquires whether any of the plurality of nodes is assigned a role of a Master Node;
(c) if the observer agent does not receive a positive response to the query, assigning (i) the role of the Master Node to the observer agent and (ii) a role of Worker Node to any node of the plurality of nodes different from the Master Node to form at least one Worker Node; and
(d) using the Master Node to (I) retrieve at least one work order and (II) orchestrate the at least one work order among any of the at least one Worker Node.

40.-60. (canceled)
